(19) United States
(12) Patent Application Publication
(10) Pub. No.: US 2018/0252796 A1
(43) Pub. Date: Sep. 6, 2018

(54) SONAR DATA COMMUNICATION AND LOCALIZATION

(71) Applicant: Driving Management Systems, Inc., San Francisco, CA (US)

(72) Inventors: Peter Qu, Palo Alto, CA (US); Kevin Packingham, San Francisco, CA (US)

(21) Appl. No.: 15/909,373

(22) Filed: Mar. 1, 2018

Related U.S. Application Data
(60) Provisional application No. 62/466,768, filed on Mar. 3, 2017.

(51) Int. Cl. G01S 5/30; H04B 11/00; H04R 1/40

(52) U.S. Cl. CPC G01S 5/30; H04R 2499/13; H04R 1/40; H04B 11/00

(57) ABSTRACT

A system includes a plurality of transmitters, in which each transmitter is configured to transmit an ultrasonic acoustic signal and at least one ultrasonic acoustic signal is a modulated ultrasonic acoustic signal. The system also includes a mobile device comprising a processor, a receiver, and instructions stored on a non-transitory memory, so that when the instructions are executed by the processor, the instructions cause the mobile device to receive the ultrasonic acoustic signal, calculate a position of the mobile device based upon one or more characteristics of the ultrasonic acoustic signals, and demodulate the modulated ultrasonic acoustic signal to obtain an information data stream.

### CROSS-REFERENCE TO RELATED APPLICATIONS

This application claims the benefit under 35 U.S.C. § 119(e) of U.S. Provisional Patent Application Ser. No. 62/466,768, entitled SONAR DATA COMMUNICATION AND LOCALIZATION, filed Mar. 3, 2017, the disclosure of which is hereby incorporated by reference herein in its entirety and for all purposes.

### BACKGROUND

Mobile devices such as wireless devices, including, for example, cellular telephones, smart phones, laptop computers, notebook computers, tablet devices (e.g., iPad by Apple®) are ubiquitous in modern society. Use of such mobile devices while operating a vehicle, however, can be hazardous. The problem is exacerbated for inexperienced operators of the vehicle, such as youngsters just learning how to drive. Rates of vehicular accidents where mobile devices are involved are rising, especially with teenagers. Text messaging while operating a moving vehicle can be dangerous and has been linked with causing accidents. More generally, operating any keyboard while operating a vehicle can be dangerous.

Thus, the widespread adoption of mobile devices and common use of the devices while driving has raised concerns about the distraction of drivers. A driver speaking or text messaging on a mobile telephone may become mentally distracted from driving and lose control of the vehicle that he or she is driving. Thus, it is not uncommon to see an individual involved in an accident who was speaking or text messaging on a mobile device rather than paying attention to the road. Studies now suggest that individuals speaking on mobile telephones while driving a car may be as impaired as a person who drives while intoxicated. Not only is the driver mentally distracted, but eyes of the driver are diverted for dialing, looking to see who an incoming call is from.

It would be highly desirable to detect the presence of a mobile device, such as a wireless device, within a vehicle and control or inhibit the operation of the mobile device.

### SUMMARY

In one aspect, a system, comprising hardware and software, using the time of flight or time of arrival of high frequency sound waves emitted via one or more transmitters to determine the position of a mobile device, comprising a receiver configured to receive the sound waves. In one aspect, the present disclosure comprises software that functions as an application that can be installed on mobile devices, such as a smartphone or a tablet, and hardware and transmitters installed in a vehicle. In various aspects, the system can utilize one transmitter, two transmitter, or three or more transmitter configurations. In various aspects, the transmitters can triangulate the position of the mobile device based on the time of flight of the transmitted acoustic signals, the amplitude of the acoustic signals when received by the mobile device, or any combination thereof. In various aspects, the transmitters can be configured to activate or deactivate various functions of the mobile devices or deliver content to the mobile devices. In various aspects, the acoustic signals transmitted by the transmitters are configured to embody data or messages that permit communication by and between the vehicle and the mobile device. In various aspects, the system is configured to simultaneously permit localization of the mobile device and communication by and between the vehicle and the mobile device.

In some aspects, a system my include a plurality of transmitters, wherein each transmitter of the plurality of transmitters is configured to transmit an ultrasonic acoustic signal and wherein at least one ultrasonic acoustic signal is a modulated ultrasonic acoustic signal, and a mobile device including a processor, a receiver, and instructions stored on a non-transitory memory. When the instructions are executed by the processor, the instructions may cause the mobile device to receive the ultrasonic acoustic signal transmitted by each of the plurality of transmitters, calculate a position of the mobile device based upon one or more characteristics of the ultrasonic acoustic signal transmitted by each of the plurality of transmitters, and demodulate the modulated ultrasonic acoustic signal to obtain an information data stream.

In some aspects of the system, the one or more characteristics of the ultrasonic acoustic signal transmitted by each of the plurality of transmitters includes a time of flight of the ultrasonic acoustic signal transmitted by each of the plurality of transmitters.

In some aspects of the system, the one or more characteristics of the ultrasonic acoustic signal transmitted by each of the plurality of transmitters includes a carrier frequency and an amplitude of the ultrasonic acoustic signal transmitted by each of the plurality of transmitters.

In some aspects of the system, each ultrasonic acoustic signal is an ultrasonic acoustic signal having a central carrier frequency within a range of 15 KHz to 25 KHz.

In some aspects of the system, each transmitter of the plurality of transmitters is a speaker disposed within a vehicle.

In some aspects of the system, when the instructions stored on the memory are executed by the processor, the instructions further cause the mobile device to determine that the calculated position of the mobile device is within a predetermined detection zone within the vehicle.

In some aspects of the system, when the instructions stored on the memory are executed by the processor, the instructions further cause the mobile device to inhibit at least one function of the mobile device when the calculated position of the mobile device is within the predetermined detection zone within the vehicle.

Some aspects of the system further include an audio system in data communication with the plurality of transmitters.

Some aspects of the system further include an audio mixer, wherein the audio mixer is configured to combine an audio output of the audio system with the ultrasonic acoustic signal transmitted by at least one of the plurality of transmitters.

In some aspects of the system, the audio system further includes an audio system circuit configured to receive an encoded wireless transmission signal from the mobile device, and wherein the encoded wireless transmission signal comprises the ultrasonic acoustic signal transmitted by at least one of the plurality of transmitters.

In some aspects of the system, the information data stream includes one or more of an identity of the transmitter transmitting the modulated ultrasonic acoustic signal, a transmitter calibration information, a carrier frequency of the modulated ultrasonic acoustic signal, a bandwidth of the modulated ultrasonic acoustic signal, phase of the modulated ultrasonic acoustic signal, a symbol encoding of the modulated ultrasonic acoustic signal, and a power level of the modulated ultrasonic acoustic signal.

In some aspects of the system, the modulated ultrasonic acoustic signal includes an ultrasonic acoustic signal having a ultrasound carrier wave modulated in one or more of an amplitude, a phase, and a frequency.

In some aspects of the system, the plurality of transmitters includes three transmitters.

In some aspects, a method may include receiving, by a receiver of a mobile device, a plurality of ultrasonic acoustic signals wherein each of the plurality of ultrasonic acoustic signals is transmitted by a transmitter and wherein at least one of the ultrasonic acoustic signals is a modulated ultrasonic acoustic signal, calculating, by the mobile device, a position of the mobile device based upon one or more characteristics of the plurality of ultrasonic acoustic signals, and demodulating the modulated ultrasonic acoustic signal to obtain an information data stream.

In some aspects of the method, demodulating the modulated ultrasonic acoustic signal includes one or more of frequency demodulating, amplitude demodulating, and phase demodulating.

In some aspects of the method, calculating, by the mobile device, a position of the mobile device based upon one or more characteristics of the plurality of ultrasonic acoustic signals includes calculating a position of the mobile device based upon a time of flight of each of the plurality of ultrasonic acoustic signals.

In some aspects of the method, calculating, by the mobile device, a position of the mobile device based upon one or more characteristics of the plurality of ultrasonic acoustic signals includes calculating a position of the mobile device based upon a carrier frequency and an amplitude of each of the plurality of ultrasonic acoustic signals.

Some aspects of the method further include determining that the calculated position of the mobile device is within a predetermined detection zone within a vehicle, and inhibiting at least one function of the mobile device when the calculated position of the mobile device is within the predetermined detection zone within the vehicle.

Some aspects of the method further include encoding, by the mobile device, at least one of the ultrasonic acoustic signals in an encoded wireless transmission signal, and transmitting the encoded wireless transmission signal to a receiving circuit in data communication with at least one transmitter of the ultrasonic acoustic signals.

### BRIEF DESCRIPTION OF THE DRAWINGS

FIG. 1 depicts a system for determining a presence of a mobile device according to some aspects of the present disclosure.

FIG. 2 depicts a system for determining a presence of a mobile device according to some aspects of the present disclosure.

FIG. 3 is a block diagram of a system for determining a presence of a mobile device according to some aspects of the present disclosure.

FIG. 4 is a graph of amplitude versus time of a demodulated ultrasound signal according to some aspects of the present disclosure.

FIG. 5 is a block diagram of a digital ultrasound communication transmitter according to some aspects of the present disclosure.

FIG. 6 is a block diagram of a digital ultrasound communication receiver according to some aspects of the present disclosure.

FIGS. 7A-D depict various forms of modulation of an ultrasound carrier wave according to some aspects of the present disclosure.

FIG. 8 is a graph demonstrating the conversion of I/Q values to polar coordinates according to some aspects of the present disclosure.

FIG. 9 is a block diagram of an I/Q modulator in a transmitter according to some aspects of the present disclosure.

FIG. 10 is a block diagram of an I/Q modulator in a receiver according to some aspects of the present disclosure.

FIGS. 11A-G depict constellation diagrams associated with a plurality of communication modulation protocols according to some aspects of the present disclosure.

FIG. 12 depicts graphs of data packets transmitted by a left acoustic channel and a right acoustic channel, according to some aspects of the present disclosure.

FIGS. 13A and 13B are block diagrams of transmitter-side filter and a receiver-side filter, respectively, according to some aspects of the present disclosure.

FIG. 14 depicts a frequency division mobile access scheme according to some aspects of the present disclosure.

FIG. 15 depicts a time-division multiple access scheme according to some aspects of the present disclosure.

FIG. 16 schematically depicts a code division multiple access scheme according to some aspects of the present disclosure.

FIG. 17 schematically depicts a geography division multiple access scheme according to some aspects of the present disclosure.

FIG. 18 is a graph of the threshold of human hearing as a function of sound frequency of the sound according to some aspects of the present disclosure.

FIG. 19 depicts graphs of the absorption coefficient of sound as a function of frequency in air at a variety of relative humidities according to some aspects of the present disclosure.

FIGS. 20A and 20B depict polar plots of directivity of a sound at 2 kHz and at 10 kHz, respectively, according to some aspects of the present disclosure.

FIG. 21 depicts multi-path phenomenon in wireless or sonar technology according to some aspects of the present disclosure.

FIG. 22 is a block diagram of a RAKE receiver according to some aspects of the present disclosure.

FIG. 23 is a block diagram of a first stereo mixing system having two speakers according to some aspects of the present disclosure.

FIG. 24 is a block diagram of a second stereo mixing system having four speakers according to some aspects of the present disclosure.

### DETAILED DESCRIPTION

Various aspects are described to provide an overall understanding of the structure, function, manufacture, and use of the devices and methods disclosed herein. One or more examples of these aspects are illustrated in the accompanying drawings. Those of ordinary skill in the art will understand that the devices and methods specifically described herein and illustrated in the accompanying drawings are non-limiting aspects and that the scope of the various aspects is defined solely by the claims. The features illustrated or described in connection with one aspect may be combined, in whole or in part, with the features of other aspects. Such modifications and variations are intended to be included within the scope of the claims.

The present disclosure describes aspects of an apparatus, system, and method for utilizing acoustic technology based on time of flight (TOF) and hyperbolic navigation in order to plot the location of a mobile device inside any contained space by measuring the timing differences of a pulse signal from any broadcast source, such as a vehicle entertainment system. In particular, the present disclosure is directed to aspects of an apparatus, system, and method for plotting the location of a mobile device, e.g., a mobile phone, within a cabin of a vehicle utilizing the speakers of the vehicle as transmitters. The speakers each transmit an ultrasonic acoustic ping or signal, which is received by a receiver, e.g., a microphone, of the mobile device to calculate the position of the mobile device based on the time delay associated with the receipt of each of the acoustic signals. Various aspects of the apparatus, system, and method can be utilized as one speaker, two speaker, or three speaker systems.

It is to be understood that this disclosure is not limited to particular aspects or aspects described, as such may vary. It is also to be understood that the terminology used herein is for the purpose of describing particular aspects or aspects only, and is not intended to be limiting, since the scope of the apparatus, system, and method for utilizing acoustic technology based on TOF and hyperbolic navigation in order to plot the location of a mobile device inside any contained space by measuring the timing differences of a pulse acoustic signal from any broadcast source is defined only by the claims.

The system can further include a logic component comprising software, hardware, or a combination thereof that is executed on the mobile device for receiving the acoustic signals, calculating the position of the mobile device based upon the received acoustic signals, and performing various other tasks, such as demodulating and filtering. In aspects, a processor of the mobile device may be coupled to a non-transitory memory that stores the logic component as executable instructions, and the processor may be operable to execute the instructions. The logic component can include a localization module for determining the position of the mobile device and a communications module for transmitting data to and from the mobile device.

Note that relative terms such as “left,” “right,” “front,” and “back” are intended solely to assist in the description of the aspects of the present disclosure and are not intended to be limiting in any way.

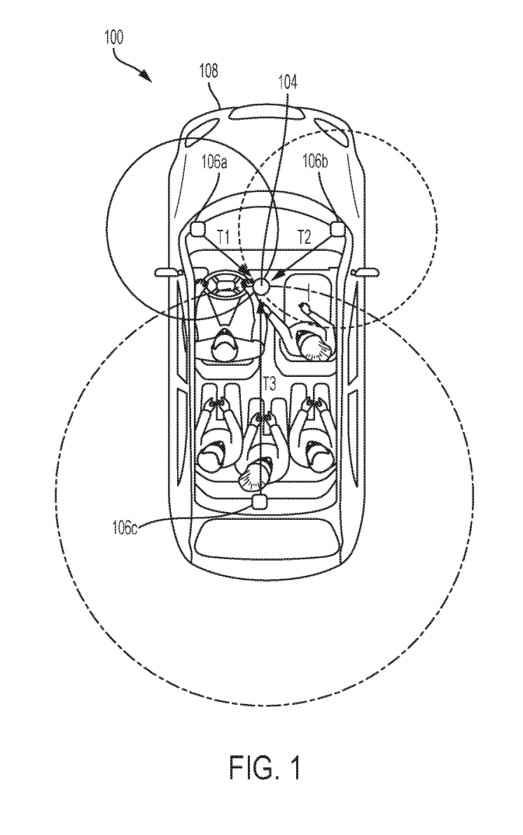

Referring now to FIG. 1, there is shown a diagram of a system 100 for determining a presence of a mobile device 104 according to an aspect of the present disclosure. The depicted aspect utilizes a configuration of three transmitters 106a-c for determining the location of a mobile device 104. When utilized in the context of a vehicle 108, the transmitters 106a-c can be the speakers of the vehicle's audio entertainment system. In one aspect of the three speaker configuration, the three speakers 106a-c are fixed at three known locations, e.g., left 106a, right 106b, and back 106c. All three speakers 106a-c can transmit ultrasonic sound pulses, i.e., acoustic signals, at a known time interval. In one aspect, the acoustic signals can be transmitted at a frequency that is above threshold of standard human hearing, i.e., the acoustic signals can be inaudible. A logic component or application on the mobile device 104 may use the built-in microphone of the mobile device 104 to detect the acoustic signals from the speakers 106a-c. As the speakers 106a-c are positioned at known, fixed locations and the ultrasonic acoustic signals are pulsed at known time intervals, the application can therefore calculate the position of the mobile device 104 with respect to the speakers 106a-c.

The application can detect the side-to-side or lateral position of the mobile device 104 relative to the speakers 106a-c based upon the difference between the flight time T1 of the acoustic signal from the first speaker 106a, and the flight time T2 of the acoustic signal from the second speaker 106b. If the mobile device 104 is closer to the first speaker 106a than to the second speaker 106b, then T1 will be shorter than T2, and vice versa. The application can detect the front-to-back position of the mobile device 104 relative to the speakers 106a-c by comparing the flight times of the acoustic signals from either the first speaker 106a, the second speaker 106b, or a combination thereof to the flight time T3 of the acoustic signal from the third speaker 106c If T3 is shorter than T1 or T2, then the mobile device 104 is closer to the third speaker 106c, and vice versa. Furthermore, the specific distances between the mobile device 104 and each of the speakers 106a-c can be determined based upon the differences in the times of flight—T1, T2, and T3—of each of the acoustic signals. In sum, in the three speaker configuration of the system, the location of the mobile device 104 can be triangulated based upon the flight times of the transmitted acoustic signals.

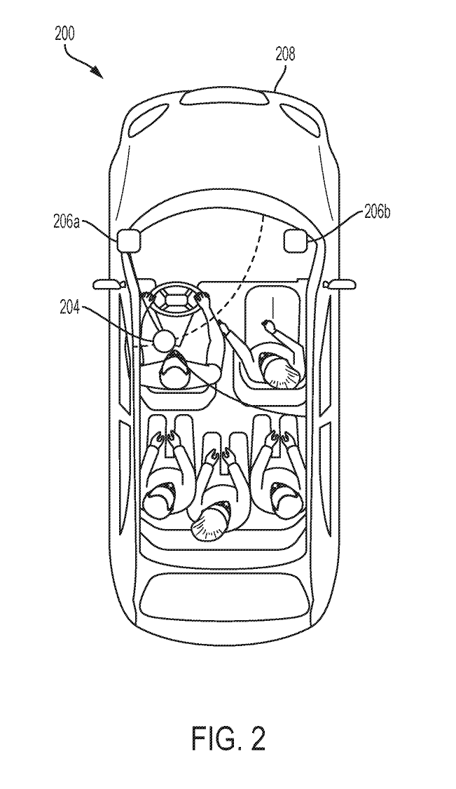

Referring now to FIG. 2, there is shown a diagram of a system 200 for determining a presence of a mobile device 204 according to an aspect of the present disclosure. The depicted aspect utilizes a configuration of two transmitters 206a,b for determining the location of a mobile device 204. When utilized in the context of a vehicle 208, the transmitters 206a,b can be the speakers of the vehicle's audio entertainment system. In one aspect of the two speaker configuration, the two speakers are fixed at two known locations, e.g., left 206a and right 206b. Each speaker 206a and 206b can transmit an acoustic signal at a known time interval. In one aspect, the acoustic signals can be transmitted at a frequency that is above threshold of standard human hearing, i.e., the acoustic signals can be inaudible. The logic component or application on the mobile device 204 uses the built-in microphone of the mobile device 204 to detect the acoustic signals from the speakers 206a,b. As the speakers 206a,b are at known, fixed locations and the acoustic signals are pulsed at known time intervals, the application can therefore calculate the position of the mobile device 204 with respect to the speakers 206a,b.

The application can detect the side-to-side or lateral position of the mobile device 204 relative to the speakers 206a,b based upon the difference between the flight time of the acoustic signal from the first speaker 206a and the flight time of the acoustic signal from second speaker 206b. In other words, if the mobile device 204 is located at the exact midpoint between the first speaker 206a and the second speaker 206b, then the flight time of the acoustic signals from the first speaker 206a and the second speaker 206b are the same. If the mobile device 204 is located closer to either one of the first speaker 206a or the second speaker 206b, then the flight time of the acoustic signal from the closer speaker will be shorter than the flight time of the acoustic signal from the farther speaker. Furthermore, the specific distances between the mobile device 204 and each of the speakers 206a,b can be determined based upon the differences in the time of flight of each of the acoustic signals. For example, if the acoustic signal from the first speaker 206a arrives 1 microsecond earlier than sound from the second speaker 206b, then the mobile device 204 is closer to first speaker 206a and the difference in distance is about 0.034 cm, given that sound travels at a speed of about 340 m/s or 0.034 cm/microsecond.

In the two transmitter configuration, the front-to-back position of the mobile device 204 can be determined relative to the speakers based upon the amplitude of each of the received acoustic signals. Because the amplitude of the acoustic signals as a function of the distance from the transmitters is known and the transmitters 206a,b are fixed in known positions, the distance from each of the transmitters 206a,b can be determined based upon the amplitude of the received acoustic signals. In sum, in the two speaker configuration of the system, the location of the mobile device can be triangulated based upon the difference in the flight times of the transmitted acoustic signals and the amplitude of each of the received acoustic signals.

In a one transmitter aspect of the present disclosure, the system may utilize the single transmitter for triggering defined activity on the mobile device.

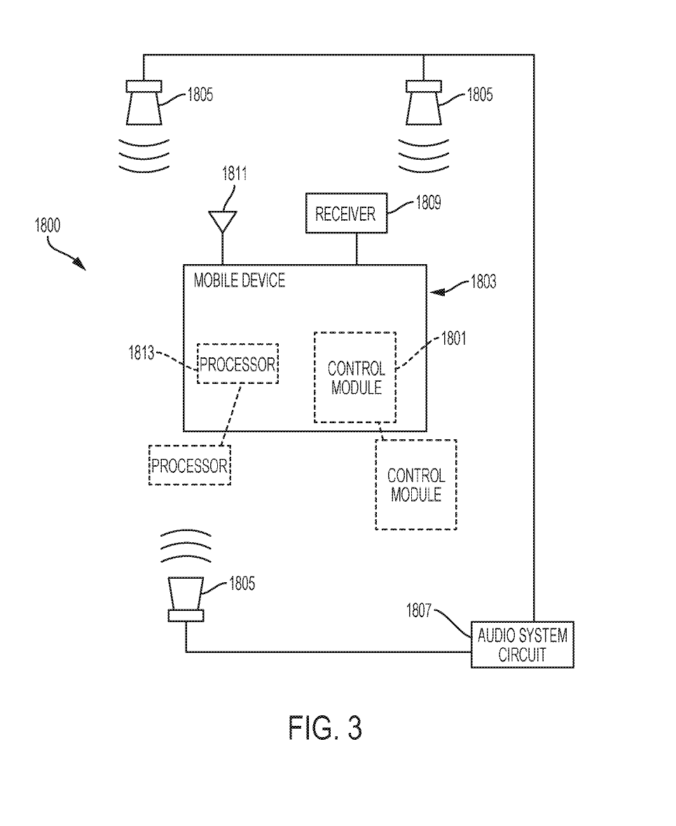

Referring now to FIG. 3, there is shown a diagram of a system for determining a presence of a mobile device according to an aspect of the present disclosure. The system 1800 of the present disclosure for determining a presence of a mobile device 1803 comprises a plurality of transmitters 1805, where each of the plurality of transmitters 1805 is configured to transmit an acoustic signal, a mobile device 1803 configured to receive each acoustic signal transmitted by each of the plurality of transmitters 1805 by an acoustic receiver 1809, and a processor 1813 configured to determine a location of the mobile device 1803 based on the acoustic signals transmitted by the plurality of transmitters 1805 and received by the acoustic receiver 1809 of the mobile device 1803.

The processor 1813 may also be configured to cause the mobile device 1803 to inhibit at least one function of the mobile device 1803 upon determining the location of the mobile device 1803. In some aspects, the processor 1813 may cause the mobile device 1803 to inhibit at least one function of the mobile device 1803 through communications with a control module 1801. In one non-limiting example, the control module 1801 may be associated with the mobile device 1803, and may be coupled to a nontransitory memory that stores executable instructions, wherein the control module 1801 is operable to execute the instructions stored in the memory. The control module 1801 may be operable to receive a command signal from a processor 1813 and inhibit at least one function of the mobile device 1803 upon reception of the command signal. In one aspect, the control module 1801 may be located within the mobile device 1803. In another embodiment, the control module 1801 may be in communication with the mobile device through a communication network, such as a wireless communication network. The control module 1801 may also be configured to inhibit the at least one function of the mobile device 1803 upon the processor 1813 determining that the location of the mobile device 1803 matches that of a predetermined detection zone. The control module 1801 may also be configured to redirect at least one function of the mobile device 1803 to a hands-free alternate system upon the processor 1813 determining that the location of the mobile device 1803 matches the predetermined detection zone.

In aspects, the system 1800 may use the TOF of the acoustic signal to determine the location of mobile device 1803. The acoustic signal may comprise at least one sonic pulse, which may be an ultrasonic pulse. In one aspect, the at least one ultrasonic pulse may be transmitted within a range of about 15 KHz to about 25 KHz. In another aspect, the at least one ultrasonic pulse may be transmitted within a range of about 18 KHz to about 20 KHz. In yet another aspect, the at least one ultrasonic pulse may be transmitted at about 19 KHz. In some examples, the ultrasonic pulse may be transmitted having a frequency of about 15 KHz, about 16 KHz, about 17 KHz, about 18 KHz, about 19 KHz, about 20 KHz, about 21 KHz, about 22 KHz, about 23 KHz, about 24 KHz, about 25, KHz, or any value or range of values therebetween including endpoints. In some aspects, the use of a narrow-bandwidth acoustic pulse or beep, for example at around 19 KHz, may allow for aggressive digital filtering to attenuate background noise. Furthermore, a narrow-bandwidth acoustic pulse or beep, for example at around 19 KHz, may improve localization sensitivity over a range of frequencies since a wider bandwidth may contain more noise in a pass band directed to such a range of frequencies. Additionally, using a narrow-bandwidth acoustic pulse or beep, for example at around 19 KHz, may allow for transmission at a lower acoustic volume.

In some examples, ultrasonic pulses may be transmitted from the mobile device 1803 as an encoded wireless transmission signal through a wireless channel, to the acoustic transmitters 1805 via an audio system circuit 1807. The acoustic transmitters 1805 and audio system circuit 1807 may be implemented as part of the audio system of a vehicle with a multi-channel surround sound system. The encoded wireless transmission signal may be transmitted by the mobile device via an antenna 1811 of the mobile device 1803. The antenna 1811 may be a component of the primary communication scheme of the mobile device 1803 or a component of a secondary communication scheme of the mobile device 1803, such as Bluetooth. The acoustic signals can be received via an acoustic receiver 1809 such as microphone of the mobile device 1803.

The localization module or algorithm can utilize multiple different methods for determining the TOF of the acoustic signals transmitted by the transmitters. In one aspect, the flight time can be estimated based on the power or strength of the acoustic signals. The power or signal strength of a wave weakens as the receiver moves further away from the transmitter. If the distance between the transmitter and receiver is R, then the power density sensed by the receiver is given by the equation below:

$${S}_{u} = \frac{{P}_{S}}{4 \cdot π \cdot {R}^{2}}$$

where Sᵤ is the received power density and Pₛ is the power from the transmitter.

In one aspect, the TOF of the acoustic signals is calculated by the localization module by detecting phase or frequency changes in the acoustic signals at the time that they are received. The method of this aspect will be discussed in the context of two speaker configurations as described above in the present disclosure; however, this is merely for illustrative purpose. In this aspect, digital communication messages are modulated into a carrier ultrasound frequency. One transmitter transmits an acoustic signal, A, at time T0 and another transmitter transmits an acoustic signal, B, at time T1. T1 and T0 do not overlap in time in order to reduce acoustic interference. T1=T0+Ts, where Ts is the time delay or separation between T0 and T1. The mobile device will receive acoustic signal A at time T0+D1/V, where V is the speed of sound and D1 is the distance from the mobile device to the left speaker. The mobile device will receive acoustic signal B at time T1+D2/V, where V is the speed of sound and D2 is the distance from the mobile devices to the right speaker. Therefore, the difference in received time of acoustic signals A and B, Td, is (T1+D2/V(T0+D1/V), which reduces to (D2−D1)=V*(Td−Ts). As the speed of sound and the time delay between the transmission of the acoustics signals are known and the time delay of the between the received acoustic signals can be detected by the mobile device, the localization algorithm can therefore solve for the relative distance of the mobile device between the transmitters, (D2−D1).

In some aspects of the present disclosure, each acoustic signal can be modulated to include information such as the identity of the transmitter (e.g., left or right speaker) that is currently broadcasting, the direction of communication (broadcast or receive), calibration information on the speaker and any one or more choice or choices of frequency, bandwidth, phase, symbol encoding, and power level of the acoustic signal.

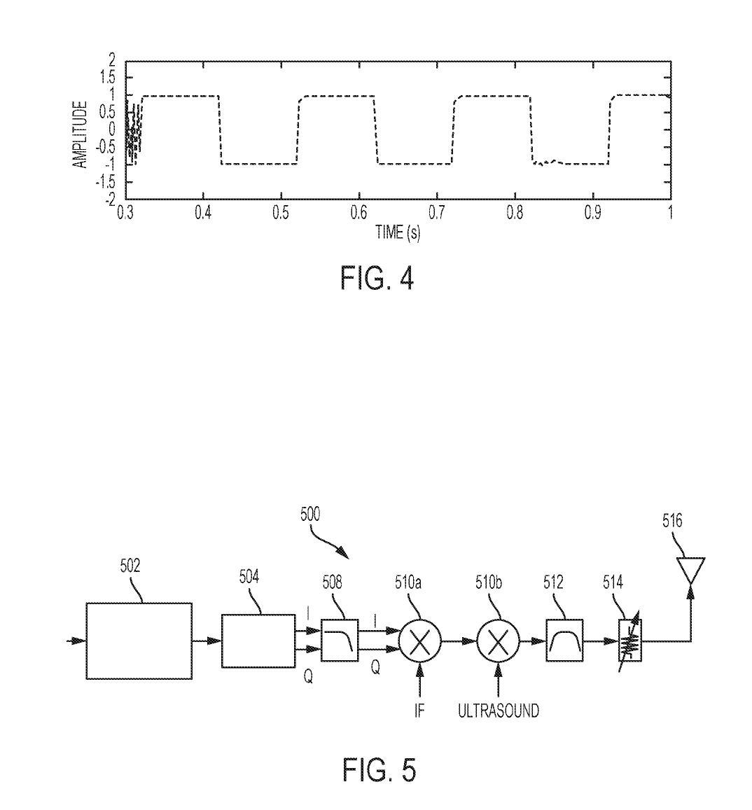

In some aspects of the present disclosure, the timing of message arrival can be calculated from each bit of data coming out of demodulation. FIG. 4 depicts a message of (1, 0, 1, 0, 1, 0, 1) resulting from demodulation of a frequency-modulated acoustic signal. As depicted in FIG. 4, the “1” bit may correspond to a positive-valued demodulated signal, and the “0” bit may correspond to a negative-valued demodulated signal The arrival time of the acoustic signal at the receiver of the mobile device can be estimated from each timing transition, either from 0 to 1 or from 1 to 0. Statistics may be calculated based on the bit transitions and used to generate the audio signal arrival time. Such statistics may reduce the effect of noise and jitter through over-sampling.

In some aspects, the mobile device can be configured to automatically negotiate connection parameters such as baud rate, frequency, bandwidth, modulation scheme, encryption option, and timing protocol with the transmitters.

In some aspects, the mobile device can be configured to auto-detect and auto-negotiate the transmission power level of the audio signal with the transmitters.

In addition to the acoustic-based system being configured to detect the relative position of the mobile device with respect to the transmitters, the acoustic-based system can also be configured to transmit data to and from the mobile device using the acoustic signal as a carrier of the data. FIG. 5 shows is a block diagram of a digital ultrasound communication transmitter system 500 according to an aspect of the present disclosure. In one aspect according to the present disclosure, the transmitter system 500 may receive data 502 as a data stream which is then encoded in an encoder 504 into symbols in order to minimize the effects of noise and interference on the ultrasonic communication channels. In some aspects, the data encoder 504 may add additional bits to the input data stream and remove redundant ones. In some non-limiting examples, the additional data bits may be used for error correction, error detection or identification, and/or message equalization.

The transmitter system 500 can additionally include one or more filters 508 to improve bandwidth efficiency and narrow the frequency spectrum of the output acoustic signals. It may be recognized that a communication system that can transmit data over an audio signal channel may make use of I/Q data techniques. It is recognized that I/Q data techniques may be useful for data encoding as phase or frequency modulation in the acoustic data channel. In some cases, the filter 508 comprises at least two filters, one for the I channel and one for the Q channel. The transmitter system 500 can then feed the filtered output from the channel encoder 504 into a modulator thereby resulting in the modulated acoustic signal. Since there are two components, I and Q, each is individually feed into the modulator. In some aspects, the modulator may be a single stage modulator that can result in a modulated acoustic signal. In some alternative aspects, the modulator may comprise a dual-stage modulator 510a,b. In this aspect, the I/Q data are used to modulate a first carrier signal having an intermediate frequency (IF) by a first modulator 510a, and then modulate a second carrier signal at the final ultrasound frequency at a second modulator 510b. Any undesirable signals that were created during the conversions are then filtered out by an output filter 512. In some aspects, the transmitter system 500 may be configured to adjust the output power 514 of the signal before the signal is provided to the output transmitter 516, such as a speaker.

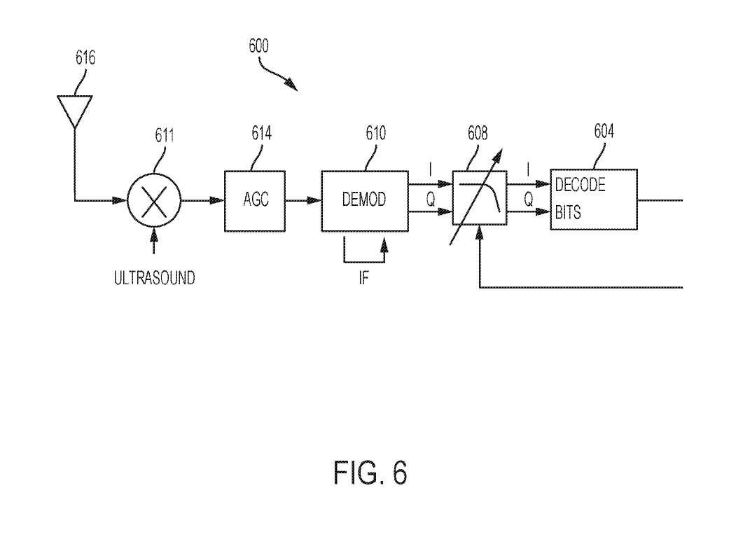

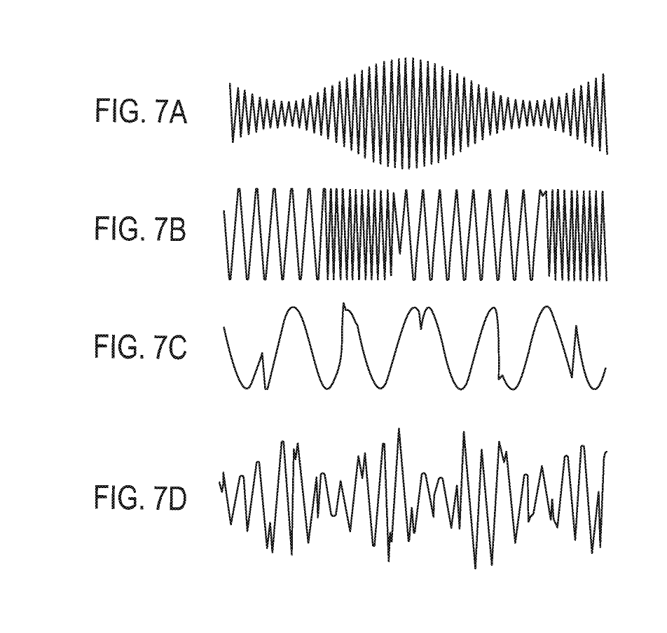

FIG. 6 shows a block diagram of a digital ultrasound communication receiver system 600 according to an aspect of the present disclosure. The incoming ultrasound signal may be received at an audio receiver 616, for example a microphone. The received signal may be down-converted to the intermediate frequency (IF) by a first demodulator 611 referencing the ultrasound carrier frequency. The gain of the output signal from the first demodulator 611 may be adjusted through the use of an automatic gain control (AGC) 614. The AGC 614 stage may be useful to compensate for signal attenuation, for example due to fading. The resulting signal, at the intermediate frequency may then be demodulated by a second demodulator 610. After demodulation, the I and Q signals may be filtered by one or more adjustable signal filters 608 and the data may be recovered by a decoder 604 to obtain data stream.

FIGS. 5 and 6 depict examples of systems designed to transmit and receive, respectively, acoustic signals having a data stream embedded therein by modulating the acoustic signal carrier wave. As depicted in FIG. 5, an acoustic signal is modulated prior to being transmitted according to the following steps: a pure carrier wave (for example, an ultrasound signal having a frequency of about 10 KHz to about 22 KHz) may be generated; and the carrier wave may be modulated with the data to be transmitted. The modulation of the carrier wave creates a reliably detectable change in the characteristic of the carrier wave. At the receiver, as depicted in FIG. 6, the received signal is demodulated, thereby revealing the data incorporated therein. FIGS. 7A-7D depict a variety of ways in which an ultrasound carrier wave can modulated. In FIG. 7A, the carrier wave is depicted as being amplitude modulated. In FIG. 7B, the carrier wave is depicted as being frequency modulated. In FIG. 7C, the carrier wave is depicted as being phase modulated. It may be recognized that the carrier wave may be modulated by any one of such methods or by any combination of such methods. Combination modulations may include, without limitation, a combination of amplitude and frequency modulation, a combination of amplitude and phase modulation (for example, as depicted in FIG. 7D), a combination of frequency and phase modulation, or a combination of amplitude, frequency, and phase modulation.

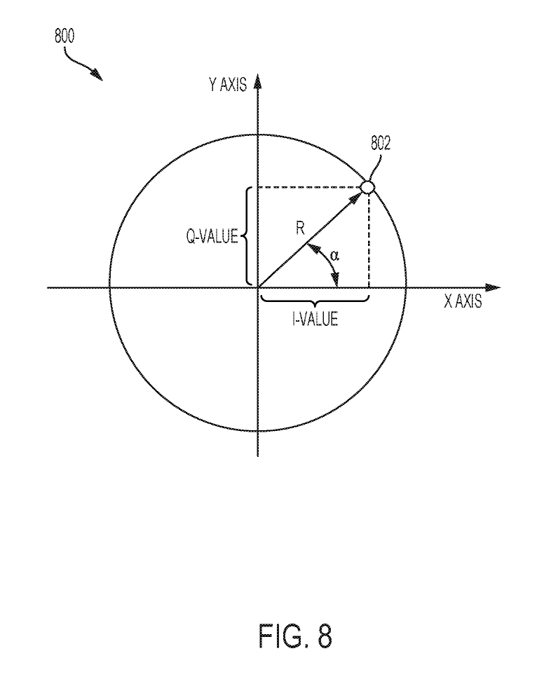

In typical digital communication, modulation is described a using polar coordinate plot 800 and I/Q formats, as depicted in FIG. 8. The communication signal may be based on the modulation of a sine wave-type carrier signal which may be characterized by A cos(2πft+φ) where A is the amplitude, f is the carrier frequency, and φ is the phase. The modulation of the carrier signal may be in any one or more of A, f, and/or cp. In a polar co-ordinates system, a point 802 may be represented by a radius R and an angle α. Thus, for a representation of the communication signal in a polar coordinate system, the radius R may equal A and the angle α may equal 2πft+φ. I and Q values may be taken as the equivalent rectangular coordinates for the polar coordinates R and α. It may be readily recognized that the I and Q values (values in an equivalent X and Y rectangular coordinate system) may be derived from the polar coordinates R and a by the transformation I=R cos α and Q=R sin α. It is recognized in a rectangular coordinate system that the Y axis (the Q signal value) is orthogonal to the X axis (the I signal value). Therefore, the Q signal is orthogonal to, or 90 degrees out of phase with, the I signal.

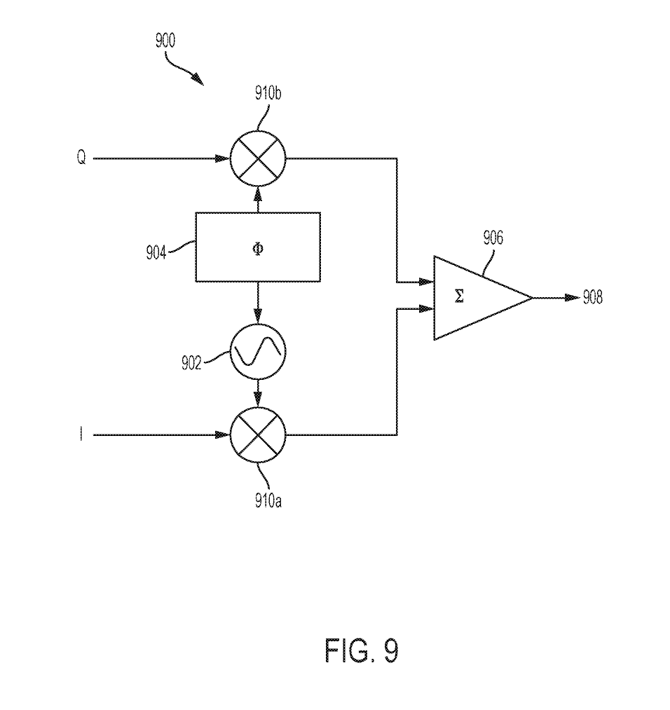

FIG. 9 shows a block diagram of an I/Q modulator in a transmitter system 900 according to an aspect of the present disclosure. A local oscillator 902 is provided having a carrier frequency of f. In a first example, the output of the local oscillator 902 is modulated by the I signal at a first modulator 910a. In the first example, the output of the local oscillator 902 is phase shifted by 90 degrees by a phase shifter 904, and the phase shifted output is modulated by the Q signal at a second modulator 910b. In a second example, the phase shifter 904 is placed in the path between the local oscillator 902 and the first modulator 910a and the resulting phase shifted signal may be modulated by the I signal instead of the Q signal. Signals that are separated by 90 degrees are orthogonal to each other and therefor do not mutually interfere. The two modulated signals may be combined at a summer 906, and the output signal 908 of the transmitter system 900 comprising a composite output of the first modulator 910a and the second modulator 910b may be sent for transmission.

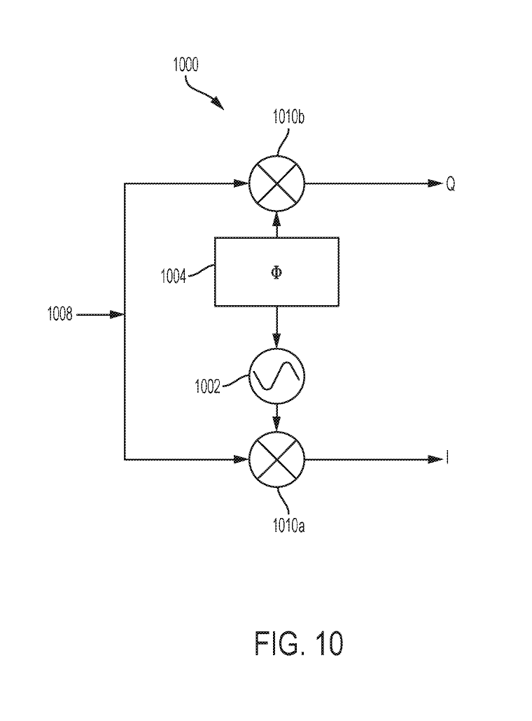

FIG. 10 depicts a block diagram of an equivalent I/Q demodulator in a receiver system 1000 according to an aspect of the present disclosure. A local oscillator 1002 is provided having a carrier frequency of f, the same as that of the transmitted signal (908 in FIG. 9). In a first example, the input signal 1008 is demodulated by the output of the local oscillator 1002 at a first demodulator 1010a. The demodulated input signal 1008 by the first demodulator 1010a results in the I signal. In the first example, the output of the local oscillator 1002 is phase shifted by 90 degrees by a phase shifter 1004, and input signal 1008 is demodulated by the phase shifted output at a second demodulator 1010b. The demodulated input signal 1008 by the second demodulator 1010b results in the Q signal. In a second example, the phase shifter 1004 is placed in the path between the local oscillator 1002 and the first demodulator 1010a.

As disclosed above, a signal may be modulated according to any one or more of an amplitude, a frequency, and a phase. Such modulation techniques may be considered analog techniques because the values for the modulated parameter may be chosen over a continuous (analog) range of values. In an alternative aspect, the signal modulation may incorporate digital modulation techniques. The present disclosure contemplates the use of one or more digital modulation formats for acoustic-based communication.

MSK, minimum shift keying, is a method where there is continuous phase frequency shift keying, similar to OQPSK. MSK encoded bits alternate between quadrature components, in which component Q is delayed by half the symbol period. OQPSK uses square pulses whereas MSK uses each bit as half sinusoid.

GMSK, Guassian minimum shift keying, is a continuous phase frequency shift keying modulation scheme. It is similar to MSK, however the data stream is first shaped using a Gaussian filter that has the benefit of reducing out of band interference from adjacent channels.

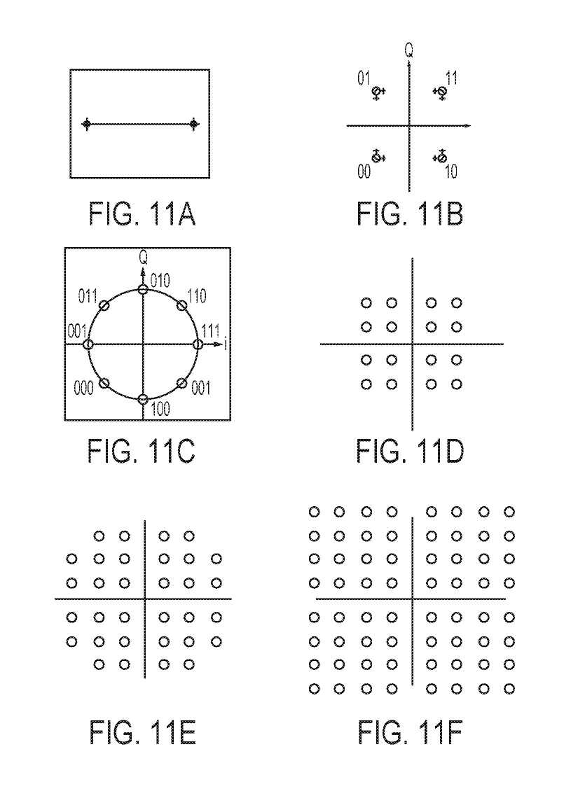

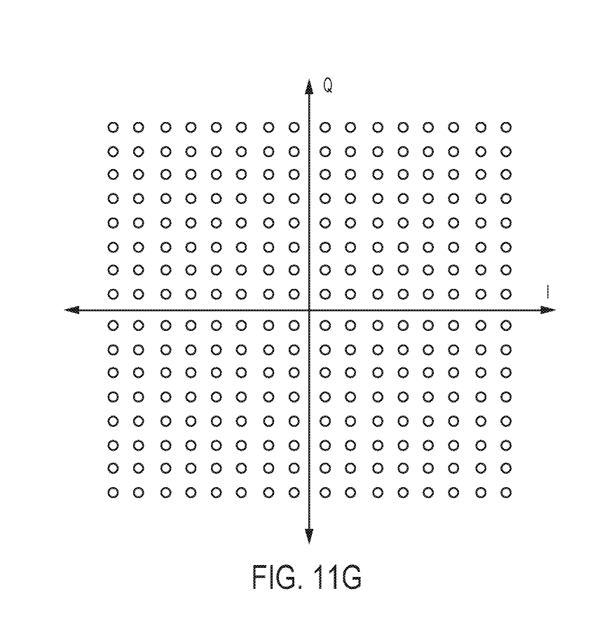

BPSK, binary phase shift keying, uses two phases separated by 180 degrees and sometimes is referred to 2-PSK (similar of 2-QAM). They constellation points, as depicted in FIG. 11A, are separated by 180 degrees and handle a high level of noise distortion which is highly desirable. However, BPSK is restricted to 1 bit per symbol, making it undesirable for high data rate applications

QPSK, quadraphrase phase shift keying, uses 4 points in the constellation, as depicted in FIG. 11B, and may result in 2 bits per symbol or twice the data rate as BPSK. While QPSK is a different key shifting method than 4-QAM, the resulting modulated waves produced are the same. QPSK can be used, instead of doubling the data-rate, to reduce the bandwidth requirement in half.

OQPSK, offset QPSK, uses four different values to transmit. Utilizing four phases at a time to transmit the signal can result in undesirable large amplitude fluctuations (i.e. QPSK) so the offset method shifts the timing of the odd and even bits by one period. Instead of 180 degree separation it is reduced to 90 degrees reducing noticeably amplitude fluctuations.

FSK, frequency shift keying, is based on free-running oscillators and switching between them at the beginning of each symbol period. Independent oscillators are not at the same phase or amplitude so in practice a single oscillator may be used, and the process of switching to a different frequency at the start of each symbol period preservers the phase. Audi FSK uses a slightly different modulation format as digital data are represented by changes in the pitch (frequency) of the audio tone, resulting in an encoded signal suitable for audio transmission. The signal data are thus encoded by two tones, a first tone representing a digital one and a second tone representing a digital zero.

GFSK, Gaussian FSK, is similar to FSK except that GFSK filters the data pulses with a Guassian filter, resulting in smoother transitions during the frequency changes. The Gaussian filtering further results in reduced interference between neighboring channels.

8 VSB, vestigial sideband modulation, is a modulation method developed initially for broadcasting using the ATSC digital television standard and used primarily in North America. The VSB method converts a binary stream into an octal representation using an amplitude shift keying method into an 8 level representation. This method encodes 3 bits per symbol. The resulting signal is then band passed through a Nyquist filter. 16 VSB is similar technique, but results in twice the data rate although it is more susceptible to noise

8 PSK, a high order PSK, is based on 8 phases in the constellation and is the highest order PSK utilized due to the higher rate of errors that occur above 8 phases. FIG. 11C depicts the constellation diagram of 8 PSK.

16 QAM, 16 Quadrature Amplitude Modulation, is based on QAM which is an analog and digital modulation method. It provides two analog signals or two digital bit streams by modulating the amplitudes of the two carriers using ASK (amplitude shift keying) or AM (amplitude modulation). The resulting two carrier waves at the same frequency are out of phase by 90 degrees and thus referred to as a quadrature carrier. The modulated waves get summed resulting in a waveform that is a combination of PSK and ASK/AM. 16 QAM results in 4 bits per symbol as depicted in FIG. 11D. The QAM protocol may be extended in terms of the number of pits per signal, thereby giving rise to 32QAM (FIG. 11E), 64 QAM (FIG. 11F), and 256 QAM (FIG. 11G).

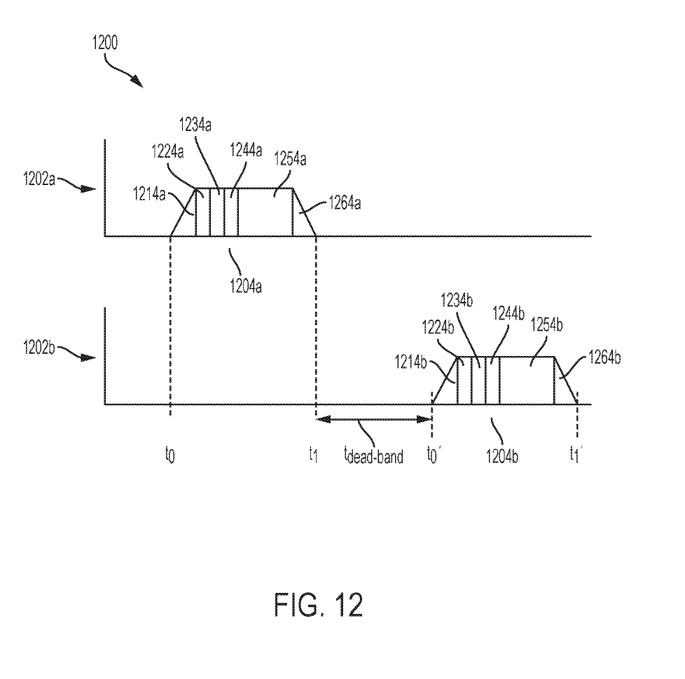

FIG. 12 depicts a use of acoustic stereo channel data communication that may be used both to determine a location of a receiving mobile device as well as to communicate information and/or instructions to the device. A communication system 1200 may comprise two acoustic transmitters, a left transmitter and a right transmitter. Each transmitter may transmit acoustic data over an acoustic channel, for example a left channel 1202a and a right channel 1202b. It may be recognized that the graphs depicted in FIG. 12 have a horizontal time axis and a vertical acoustic amplitude axis. The acoustic data may comprise an acoustic packet, such as a left acoustic packet 1204a and a right acoustic packet 1204b. Each acoustic packet may be characterized by a start time (t₀ for the left acoustic packet 1204a and t₀′ for the right acoustic packet 1204b), and an end time (t₁ for the left acoustic packet 1204a and t₁′ for the right acoustic packet 1204b). The difference between t₁ and t₀′ is fixed and set to allow sufficient t_{dead-band}, wherein t_{dead-band}=t₀′−t₁. T_{dead-band} may be chosen to ensure that the right acoustic packet 1204b does not temporally overlap the left acoustic packet 1204a. The mobile device may receive both the left acoustic packet 1204a and the right acoustic packet 1204b and measure the time difference between the received t₀ and t₀′. If the measured time difference between t₀ and t₀′ deviates from their known fixed value, then relative location of the mobile device with respect to the audio transmitters can be calculated using time difference and speed of sound. In this manner, the mobile device may use some characteristics (start and stop times) of the left acoustic packet 1204a and the right acoustic packet 1204b to determine positional information.

As disclosed above, the mobile device may determine its location based on a time difference calculated from the receipt of two acoustic packets. A pair of acoustic packets solely comprising short burst acoustic signals at a carrier frequency may be used in an acoustic-based device localization method. However, as disclosed above, the acoustic signal carrier may be modulated in such a manner that additional data may be encoded therein. In some non-limiting examples, the data content of each acoustic packet 1204a,b may be formatted in a known manner. In one non-limiting example, a data packet (1204a,b) may be formatted into six components. As depicted in FIG. 12, the components are labeled as an “a” component for the left data packet 1204a and a “b” component for the right data packet 1204b, respectively. The components may comprise: the ramp up of the carrier frequency (1214a,1214b), the preamble (1224a,1224b), the sync (1234a,1234b), the header (1244a,1244b), the payload (1254a,1254b), and the ramp down (1264a,1264b) of the signal level to zero.

In some aspects, the preamble component (1224a,1224b) may be a sequence that allows the algorithm to detect the start of the data frame/packet. The sync component (1234a,1234b) may a sequence that allows the detector to sync the frequency and phase of the modulated carrier. This sequence may include alternating bits, such as 010101 . . . or a pseudo-noise sequence. This sequence allows the detector to determine the timing of data packet and calculate t₀/t₁. The header component (1244a,1244b) may contain information about the data payload (such as symbol encoding, for example ASCII encoding). The payload component (1254a,1254b) comprises the data to be received and acted upon by the mobile device.

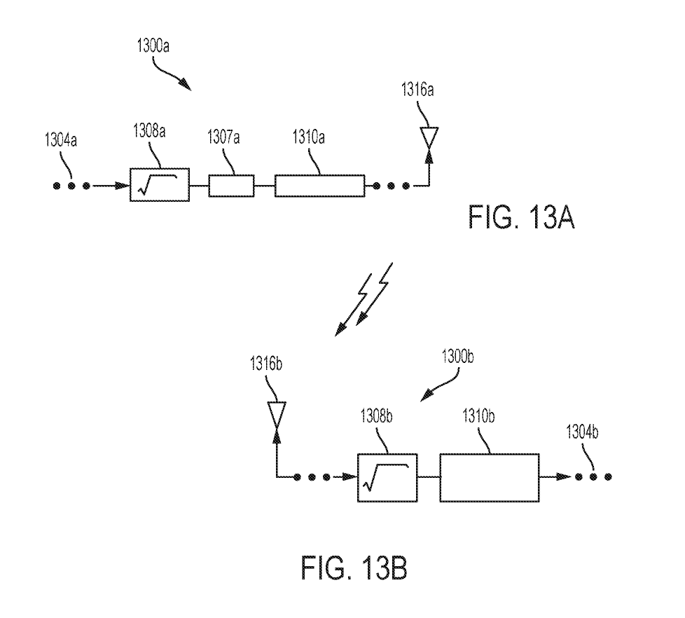

The acoustic signals utilized by the present system can be transmitted at an ultrasonic frequency, such as a frequency within the range of about 15 KHz to about 25 KHz, which is inaudible to humans. In some aspects of the present disclosure, one or more filters may be applied in a transmitter system 1300a as depicted in FIG. 13A. The transmitter system 1300a may receive digital data 1304a and apply one or more types of filters 1308a to the data 1304a. In some aspects, the original data 1304a may be represented as digital data. In such aspects, the filter 1308a may be realized as a digital filter. The digital output of the filter 1308a may be converted to an analog signal by a digital-to-analog converter 1307a. The resulting analog output may be used by a modulator 1310a to modulate a carrier signal characterized by an ultrasonic frequency. The resulting modulated ultrasonic signal may be transmitted by a transmitting device 1316a, for example one or more speaker. In other aspects, one or more filters may be applied in a receiver system 1300b as depicted in FIG. 13B. The receiver system 1300b may receive ultrasonic audio data by a receiving device 1316b, for example a microphone. The electrical signal output from the receiver device 1316b, may be filtered by one or more filter devices 1308b. The output of the receiver filter 1308b may be demodulated 1310b using an oscillator signal having the same frequency as the transmitter carrier signal frequency. The demodulated signal may then comprise receiver data 1304b substantially the same as the digital data 1304a transmitted by the transmitter system 1300a. In still other aspects, filters are applied in both a transmitter system 1300a depicted in FIG. 13A and in a receiver system 1300b as depicted in FIG. 13B.

Various filtering techniques, as implemented in filters 1308a,b, may allow the data to be transmitted at a specific frequency and reduce the bandwidth requirement at the same time. In some aspects, the filtering techniques may be implemented using electronic hardware devices including, without limitation, any one or more of resistors, capacitors, inductors, operational amplifiers, comparators, and voltage and/or current references. In some other aspects, the filtering techniques may be implemented as digital instructions stored in a volatile or non-volatile memory device and used by a processor to filter a digital representation of a signal by means of arithmetic and/or logical operations. Some non-limiting examples of filtering techniques may include: raised cosine, square root raised cosine, Gaussian raised cosine, and Chebyshev equiripple FIR filters. Filtering in the transmitter side (transmitter filter 1308a) reduces adjacent-channel-power radiation of the transmitter and thus interference. Filtering in the receiver side (receiver filter 1308b) reduces the effect of noise and interference from other nearby transmitters. Often the variation in the phase state, may result in blurring of the data symbols. Gaussian filters can be used in such cases because they have less ringing compared to raised cosine filters.

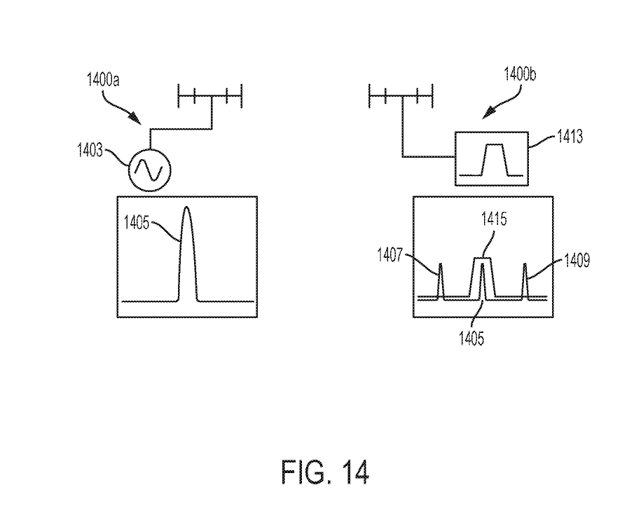

In some aspects, the present system is configured to communicate with multiple mobile devices. The technique that allows multiple mobile devices to share the same communication channel, such as sonar, is called multiplexing. FIG. 14 is an illustration of a frequency division mobile access scheme according to an aspect of the present disclosure. Frequency Division Multiple Access (FDMA) splits the available frequency band into smaller fixed frequency channels. Each mobile device transmits over a separate frequency band. As depicted in FIG. 14, transmitter system 1400a may have a local oscillator 1403 to generate a carrier frequency 1405 for transmitting information. Although not shown, one or more additional transmitter systems, similar to 1400a, may each have a local oscillator similar to 1403 and which is able to generate a carrier frequency that differs from that of carrier frequency 1405. For example, if two mobile devices are communicating over a frequency band from 18.0 KHz to 19.0 KHz, a first transmitter device (for example 1400a) can use frequency 18.0-18.3 KHz (for example 1405) while the second device (not shown) can use 18.7-19.0 KHz. The frequency band for each device is separate from the frequency band for another device.

The receiver device 1400b may receive the acoustic signal transmitted by one or more transmitter devices (such as 1400a), and apply a narrow-band filter 1413 to its input signal. The narrow-band filter 1413 may be centered at one of several different filter frequencies 1415 designed to band pass only those signals corresponding to a particular transmitter system 1400a. As depicted in FIG. 14, the narrow-band filter 1413 has its center filter frequency 1415 chosen to band-pass a signal at a frequency 1405 as transmitted by the transmitter device 1400a. However, the receiver device 1400b may be configured to change the center filter frequency 1415 to any one or more alternative values, thereby permitting receipt of signals transmitted by alternative transmitter devices at alternative frequencies such as at frequency 1407 or 1409.

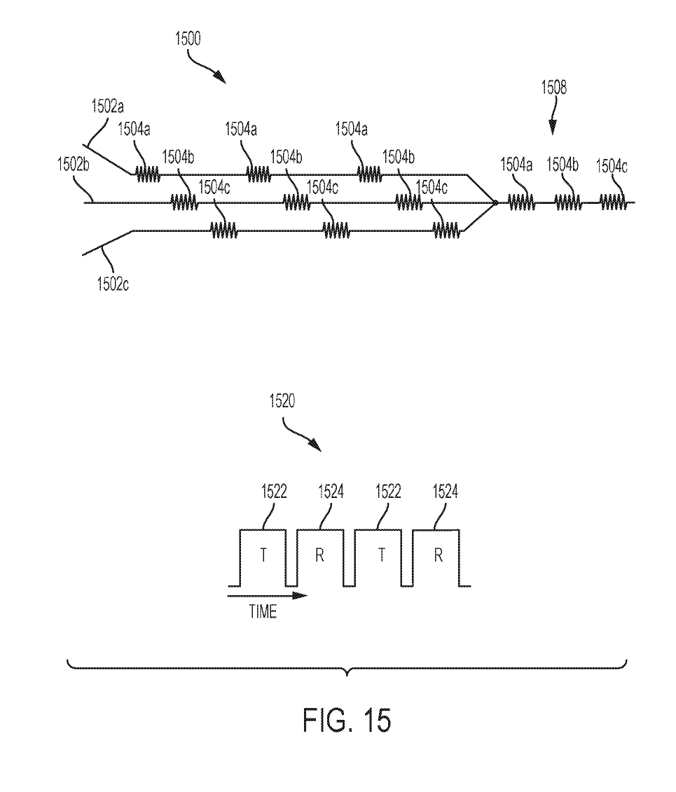

Another multiplexing technique is time-division multiple access (TDMA). FIG. 15 shows an illustration of a time-division multiple access system 1500 according to an aspect of the present disclosure. Time-division multiple access requires that each transmitter transmit at different time, so that the group of transmitters don't all transmit at same time. As depicted in FIG. 15, each of several transmitters (1502a-c) transmits a signal over the same communication channel (for example, each transmitter 1502a-c uses the same carrier frequency for the communication). However, the communication packets 1504a transmitted by transmitter 1502a are temporally spaced with respect to the communication packets 1504b transmitted by transmitter 1502b and with respect to the communication packets 1504c transmitted by transmitter 1502c. The receiver 1508 receives all of the transmissions of transmitters 1502a-c at the same carrier frequency, but is programmed to associate a received communication packet at a specific time duration with only one of the transmitters 1502a-c.

The TDMA protocol may be extended to multiple devices that can both transmit and receive transmission packets. In Time Division Duplexing (TDD) 1520 each communicating device is allocated one or more time slots during which it can transmit data 1522 and one or more time slots during which it can receive data 1524 from any one or more devices in a transmission mode.

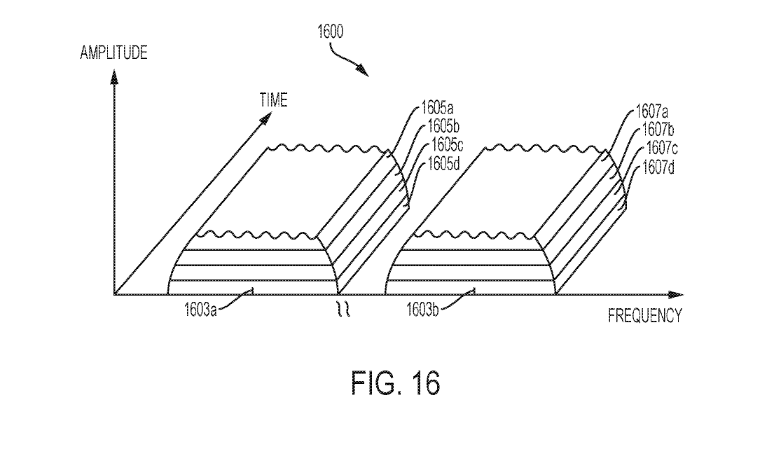

Yet another multiplexing technique is code division multiple access (CDMA). FIG. 16 illustrates the application of a CDMA encoding protocol 1600 among a number of transmitting devices according to an aspect of the present disclosure. In CDMA, multiple transmission devices can transmit simultaneously using the same carrier frequency (for example, at frequency 1603a or at frequency 1603b). In CDMA systems, each transmitter system has a unique encoding string that is mixed with the data (for example using an XOR function) prior to transmission. In some examples, each of the encoding strings comprises a pseudo-random digital string. In some alternative examples, the encoding strings are mutually orthogonal under a mixing operation. FIG. 16 depicts communications from multiple transmitting devices using the same carrier frequency (for example 1603a) and occurring during the same time period. Each transmitter is assigned an encoding string to encode its transmission. As depicted in FIG. 16, a first transmitter, operating at a first carrier frequency 1603a, may issue a first transmission 1605a encoded by a first encoding string, a second transmitter may issue a second transmission 1605b encoded by a second encoding string, a third transmitter may issue a third transmission 1605c encoded by a third encoding string, and a fourth transmitter may issue a fourth transmission 1605d encoded by a fourth encoding string, All of these transmissions 1605a-d may be issued at the same time. Similarly, a second transmitter, operating at a second carrier frequency 1603b, may issue a first transmission 1607a encoded by a first encoding string, a second transmitter may issue a second transmission 1607b encoded by a second encoding string, a third transmitter may issue a third transmission 1607c encoded by a third encoding string, and a fourth transmitter may issue a fourth transmission 1607d encoded by a fourth encoding string, All of these transmissions 1607a-d may also be issued at the same time. A receiver device may receive the aggregate of all of the transmissions 1605a-d and 1607a-d and perform a correlation analysis thereon based on each of the encoding strings. As a result of the correlation analysis, the receiver may be able to decode the data transmitted from each of the transmitters individually.

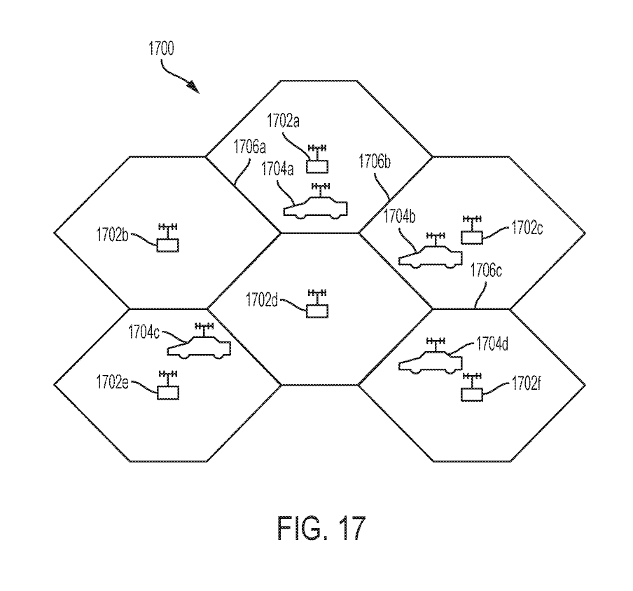

Yet another multiplexing technique is geography division multiple access (GDMA). FIG. 17 is an illustration of a GDMA scheme according to an aspect of the present disclosure. In GDMA, transmitters are placed far enough apart such that neighboring devices do not interfere with each other. In the context of a GDMA scheme, an advantage of using sound as the medium for the transmitted signals is that sound can be easily blocked by sound absorbing surfaces. Therefore, the system can provide good isolation for the acoustic signals. Furthermore, the range of detection in a GDMA scheme can be tuned using power, frequency, and directionality: Higher power is associated with higher range, higher frequency is associated with shorter range and more directionality, and narrower directionality results in the acoustic signals only being detectable within the direction of the sound.

As one example, a building can be configured with multiple separate rooms, each room with a sonar transmitter and wherein the sound from neighboring rooms cannot be picked up by mobile devices. In other words, when the mobile device is in a room, it can only pick up signal from a sonar transmitter in that room. This scheme provides both an accurate location of mobile devices within the building and also offers a target communication to devices in each individual room.

As another example, a system 1700 can be directed to determining whether a mobile device is inside or outside of a vehicle. The system can include one or more sonar transmitters T_INSIDE 1704a-d inside of a vehicle and sonar transmitter T_OUTSIDE 1702a-f outside of the vehicle. Each T_INSIDE 1704a-d and T_OUTSIDE 1702a-f transmitter emits a different signal (different in message, frequency, phase, amplitude, etc.) such that the mobile device can discern between T_INSIDE 1704a-d and T_OUTSIDE 1702a-f. The structure of the automobile prevents sound from easily travelling into and out of the vehicle and therefor acts as a an acoustic barrier between the T_INSIDE 1704a-d and T_OUTSIDE 1702a-f transmitters. If the mobile phone is inside the vehicle, T_INSIDE 1704a-d will have the strongest signal. If mobile phone is outside of the vehicle, T_OUTSIDE 1702a-f will have the strongest signal. Therefore, the mobile device can discern between T_INSIDE 1704a-d and T_OUTSIDE 1702a-f and thus determine its position relative to the vehicle. The mobile device may also distinguish among the several T_OUTSIDE 1702a-f devices because the acoustic signal may be configured to have a defined radius of transmission, for example based on the output power of the T_OUTSIDE 1702a-f transmitter. A mobile device within a radius of transmission of a first T_OUTSIDE device (for example 1702a) may receive messages only from the first T_OUTSIDE device (for example 1702a) but will be too far away from a second T_OUTSIDE device (for example 1702b) to receive messages from the second T_OUTSIDE device (for example 1702b). The radius of transmission defined for each T_OUTSIDE 1702a-f device may be considered equivalent to a virtual acoustic containment wall 1706a-c.

The aforementioned multiplexing techniques can additionally be combined together in any number of combinations or with additional multiplexing techniques. For example, FDMA, TDMA, GDMA, and frequency division duplexing (FDD) can be combined together into a hybrid multiplexing scheme. As another example, FDMA, GDMA, and time division duplexing (TDD) can be combined together into a hybrid multiplexing scheme.

The frequency at which the acoustic signals are transmitted additionally depends on several factors, including the sampling rate of the transmitter and receiver, the sensitivity of human hearing, the range of ultrasound, and the directionality of ultrasound. As to the sampling rate of the transmitter and receiver, the sensitivity of microphones and efficiency of speakers varies among different make and model. The choice of frequency can be made such that most common microphones and speakers can receive and emit the frequency. In one aspect of the present disclosure, the acoustic signals are transmitted at a frequency of between 20 Hz to 22 KHz. In another aspect, the acoustic signals are transmitted at a frequency of up to 400 KHz.

Another factor to consider in selecting the frequency range at which the acoustic signals are transmitted is the effect of aliasing. The Nyquist theorem states that the highest frequency component that can be detected without aliasing effect is half of the sampling frequency. Therefore, in one aspect the combined carrier frequency and data frequency do not exceed one-half the sampling frequency. Table 1, below illustrates this restriction for some common sampling frequencies.

TABLE 1
Sampling Frequency and Maximum Carrier Frequency

| | Maximum Allowed Carrier and Data |
|---|---|
| Sampling Rate | Frequency |
| 44.1 KHz | 22.05 KHz |
| 48 KHz | 24.0 KHz |
| 64 KHz | 32.0 KHz |
| 88.2 KHz | 44.1 KHz |
| 96 KHz | 48 KHz |
| 128 KHz | 64 KHz |
| 256 KHz | 128 KHz |
| 512 KHz | 256 KHz |
| 1024 KHz | 512 KHz |

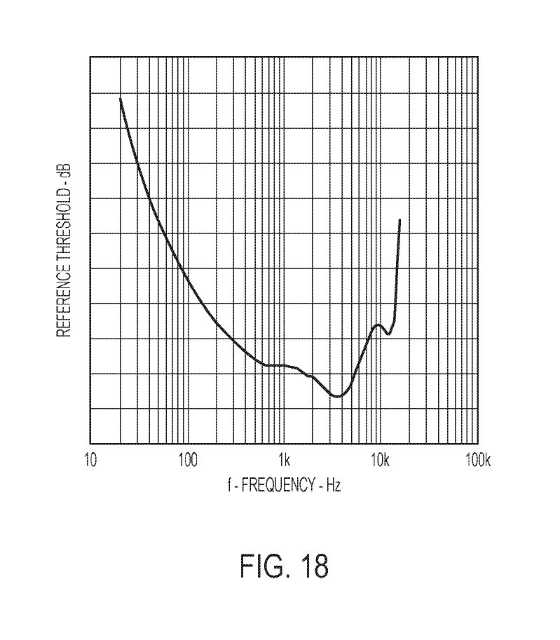

In one aspect of the present disclosure, the acoustic signals are broadcast at an ultrasonic frequency above the range of standard human hearing. FIG. 18 depicts the power of sound at various frequencies that can be heard by a human. The sensitivity of human hearing decrease significantly when sound frequency is above 10 KHz. The slope is especially steep for frequency above 15 kHz. In one aspect, the acoustic signals may be transmitted at a frequency above 10 KHz. In another aspect, the acoustic signals may be transmitted at a frequency above 15 KHz.

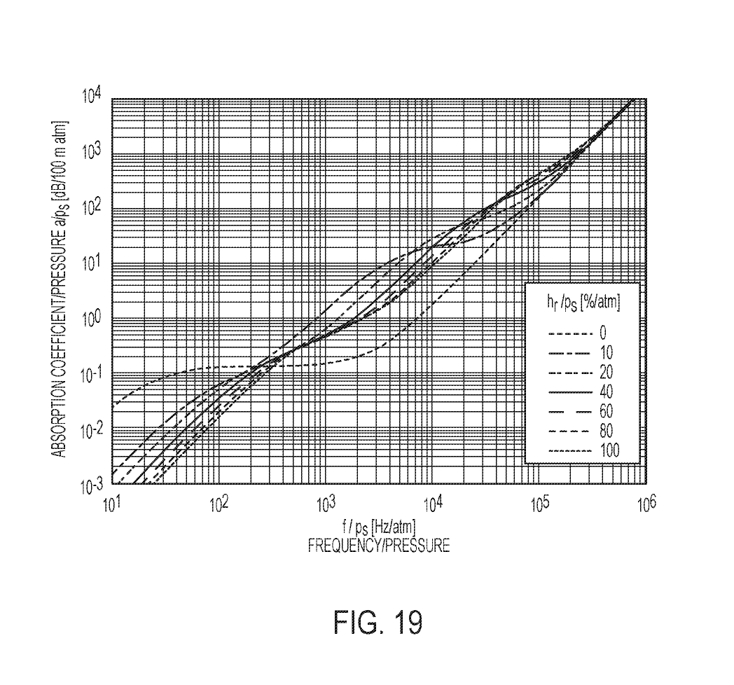

The frequency of the acoustic signals also affects the range of the signals. FIG. 19 depicts the absorption coefficient of the sound as a function of frequency for air at 20 C.° normalized to 1 atmosphere. The higher the frequency, the higher the absorption coefficient of the sound. At very high frequencies, the atmosphere readily absorbs the sound and the range of the sound is short. In some aspects, the absorption coefficient may be dependent on the air temperature and relative humidity. Furthermore, this property can be utilized as an additional method for determining the TOF of the acoustic signals. Acoustic signals having identical acoustic power but differing carrier frequencies may be transmitted by the acoustic transmitters, and the receiver can calculate the distance of the mobile device from the transmitters by analyzing the relative attenuation of each of the acoustic signals.

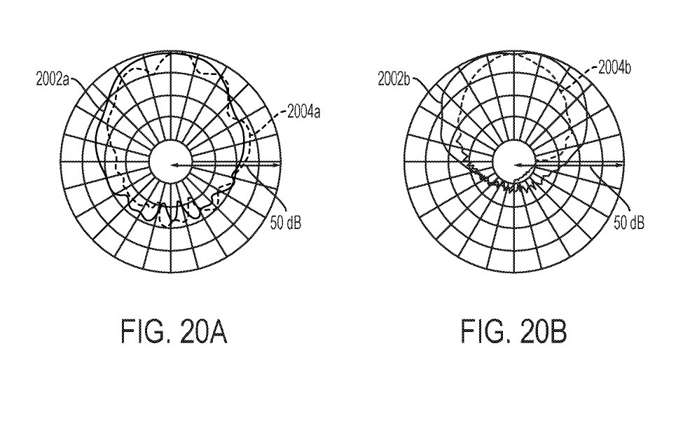

Yet another factor affecting the selection of the frequency at which the acoustic signal is transmitted includes the dispersion characteristics of the sound waves. As depicted in FIGS. 20A,B, sound waves at higher frequencies have less dispersion than at lower frequencies. Thus, FIG. 20A depicts the power dispersion of a 2 KHz sound wave (in the horizontal 2002a and vertical 2004a directions, respectively). FIG. 20B depicts the power dispersion of a 10 KHz sound wave (in the horizontal 2002b and vertical 2004b directions, respectively). In one aspect of the present system configured to target a receiver at a particular spot, the system may include high frequency, directional transmitters.

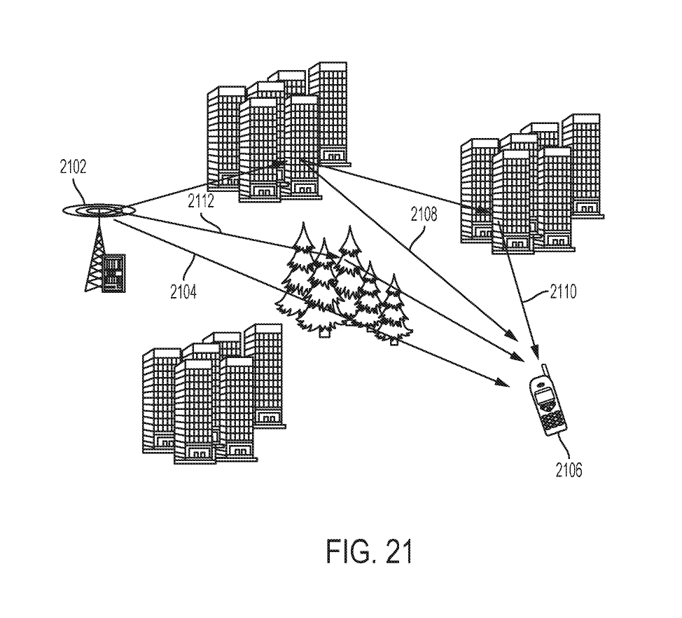

The multi-path transmission errors may affect acoustic wave transmissions as with other types of communication transmissions (e.g. RF transmission). FIG. 21 depicts aspects of multi-path transmission errors. An original signal 2102 may be transmitted by a transmitter and may be received, for example, in direct line of sight 2104 by the mobile device 2106. However, the transmitter will also transmit a signal that may be reflected 2108 by any object before being received by the mobile device 2106. Additional signals may be diffracted 2110 before being received or may be scattered 2112 before being received by the mobile device 2106. The reflected 2108, diffracted 2110, and scattered 2112 signals may all be received by the mobile device 2106 but at various times delayed from the receipt of the original line of sight 2104 signal. Each of the signals received by the mobile device 2106 may also be attenuated by a different amount depending on the particular path taken and any intervening objects. Therefore, the mobile device 2106 may require additional analysis features to address potentially confusing redundant signals received from the transmitter.

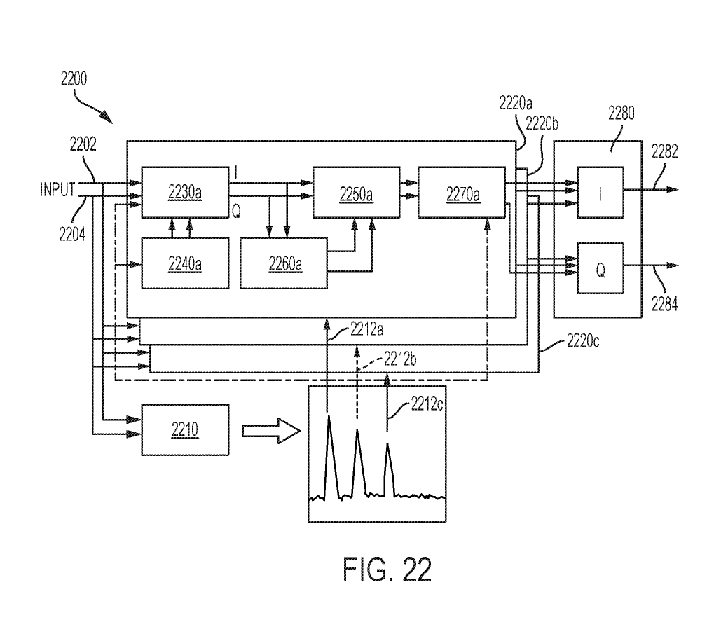

Referring now to FIG. 22, there is shown a block diagram of a rake receiver 2200 according to an aspect of the present disclosure. Such a rake receiver 2200 may be used to address the potential self-interference issue presented by the multi-path problem. A rake receiver 2200 may be used to overcome the problem of self-interference due to the reception of multiple transmissions, each one comprising a delayed and/or attenuated version of an original transmission. A rake receiver 2200 may be composed of an antenna to receive the multiple transmissions thereby providing an input signal composed of an I input component 2202 and a Q input component 2204. The rake receiver 2200 may also include a matched filter 2210 and a plurality of finger receivers 2220a-c, each finger receiver 2220a-c being responsive to one of the multiple transmissions. The rake receiver 2200 may also include a combiner 2280 configured to combine the I and Q outputs produced by each of the finger receivers 2220a-c into a single output composed of an I output component 2282 and a Q output component 2284.

The matched filter 2210 performs an impulse response measurement of the combined I input component 2202 and Q input component 2204. It decomposes the combined I input component 2202 and Q input component 2204 resulting from the multipath channel into time based peaks 2212a-c, in which each of the time based peaks 2212a-c corresponds to one of the multipath components. The timing information associate with each of the time based peaks 2212a-c is associated with one of the multiple finger receivers 2220a-c. In some aspects of CDMA systems, this is typically done by matched filtering the incoming RF signal with a known sequence of pilot chips.

As disclosed above, the rake receiver 2200 includes multiple finger receivers 2220a-c, in which each finger receiver (for example finger receiver 2220a) is responsive to one of the multipath components of the combined I input component 2202 and Q input component 2204. Although the description herewith is provided with respect to a first finger receiver 2220a, it may be recognized that similar descriptors may apply to each of the additional finger receivers 2220b,c. As one example, a first time based peak 2212a associated with a first multipath component may be provided by the matched filter 2210 to a first finger receiver 2220a. Similarly, a second time based peak 2212b associated with a second multipath component may be provided by the matched filter 2210 to a second finger receiver 2220b, and a third time based peak 2212c associated with a third multipath component may be provided by the matched filter 2210 to a third finger receiver 2220c. Components of the first finger receiver 2220a having an “a” designation in the reference number can be considered as equivalent to components having a “b” designation in reference numbers (not shown) for the second finger receiver 2220b and a “c” designation in reference numbers (not shown) for the third finger receiver 2220c. Additionally, it may be understood that a rake receiver 2200 may not be limited to only three finger receivers 2220a-c, but may incorporate any number of finger receivers as may be required to filter a multipath signal.

Returning to FIG. 22, one of each of the time based peaks 2212a-c may be provided to a finger receiver (2220a-c, respectively) to provide time based information relative to each of the multipath components of the input signal. Thus, using finger receiver 2220a solely as an example, an offset time with respect to a first time based peak 2212a may be supplied to components including a correlator 2230a, a code generator 2240a, and a delay equalizer 2270a, as disclosed as follows.

In each rake finger, a correlator 2230a receives the I input component 2202 and Q input component 2204 in addition to offset timing information associated with one of the time based peaks (2212a). The correlator 2230a correlates the I input component 2202 and Q input component 2204 with a code generated by a code generator 2240a. The code generated by the code generator 2240a is offset in time according to the offset timing information associated with one of the time based peaks (2212a) thereby producing a correlation with only that multipath component associated with the selected time based peak (for example, 2212a). In this manner, each multipath component is selected by only one of the finger receivers (for example, 2220a). The correlator 2230a therefore essentially functions as a box-car low-pass filter and provides, as an output, a signal derived from an isolated multipath component of the received signal.

The output of the correlator 2230a is then applied to a channel estimator 2260a which estimates the amplitude and phase of the correlator output. As disclosed above with respect to FIG. 11A-G, signal information may be encoded in the input signal as discrete values in both the amplitude and phase of the signal (see especially, the constellation diagrams for 16QAM (FIG. 11D), 32 QAM (FIG. 11E), 64 QAM (FIG. 11F), 256 QAM (FIG. 11G)). It may be recognized that the processes resulting in the multipath components of the signals may also alter the amplitude and/or phase of the received multipath component. As a result, the received amplitude and/or phase information may not be identically that which may be expected by the modulation scheme. Thus, the channel estimator 2260a may receive the isolated multipath component from the correlator 2230a and use statistical methods to estimate the actual amplitude and phase information encoded in the originating signal.

Next, the isolated multipath component from the correlator 2230a and the estimated signal encoding from the channel estimator 2260a are applied to a phase de-rotator complex multiplier 2250a, which essentially multiplies the correlator 2230a output by the complex conjugate of the channel estimate. This rotates all of the phases of the isolated multipath component so that they all have the same phase and will add coherently.

The delay equalizer 2270a delays each of the isolated multipath components according to the time based peak 2212a provided to the finger receiver 2220a. The individual I and Q outputs of each of the delay equalizers 2270a of each of the finger receivers 2220a is summed in the output combiner 2280. The applied time delay to the I and Q signals by the delay equalizer 2270a results in a temporal overlap of the individual multipath components. For example, as depicted in FIG. 22, if there are 3 main peaks 2212a-c from the matched filter 2210, the I and Q output of the first finger receiver 2220a and the I and Q output of the second finger receiver 2220b are delayed with respect to the I and Q output of the third finger receiver 2220c so that all of the I outputs and all of the Q outputs add together at the same relative time. The output combiner 2280 at the back-end adds the phase-aligned and time-aligned signals together to maximize the SNR of the final I output component 2282 and Q output component 2204

In another aspect, a receiver may include a Kalman filter to estimated delays of multipath channels. Once the multipath effect is estimated, the multipath effect can be filtered by the Kalman filter in order to improve the signal to noise ratio of the acoustic signal.

In one aspect, the transmitters can be configured to intelligently control the transmission power in order to minimize the transmission power while maintaining communication integrity and ensure that signals from different transmitters at different distances away from the receiver arrive at the receiver at approximately the same amplitude or received power. This is also known as near-far problem. In one aspect, the transmitters include a feedback power control loop that measures transmission power, computes the measured transmission power against a desired target transmission power, and then adjusts the output transmission power. In one aspect, the transmitters include multiple feedback power control loops. In one aspect, multiple feedback control algorithms can be implemented including, without limitation, power-balanced power control (PBPC), received signal power control (RSPC), second order constrained power control (CSOPC), centralized power control, distributed power control, distributed constrained power control (DCPC), constrained minimum power assignment (CMPA), unconstrained second order power control (USOPC), or any combination or combinations of the aforementioned techniques.

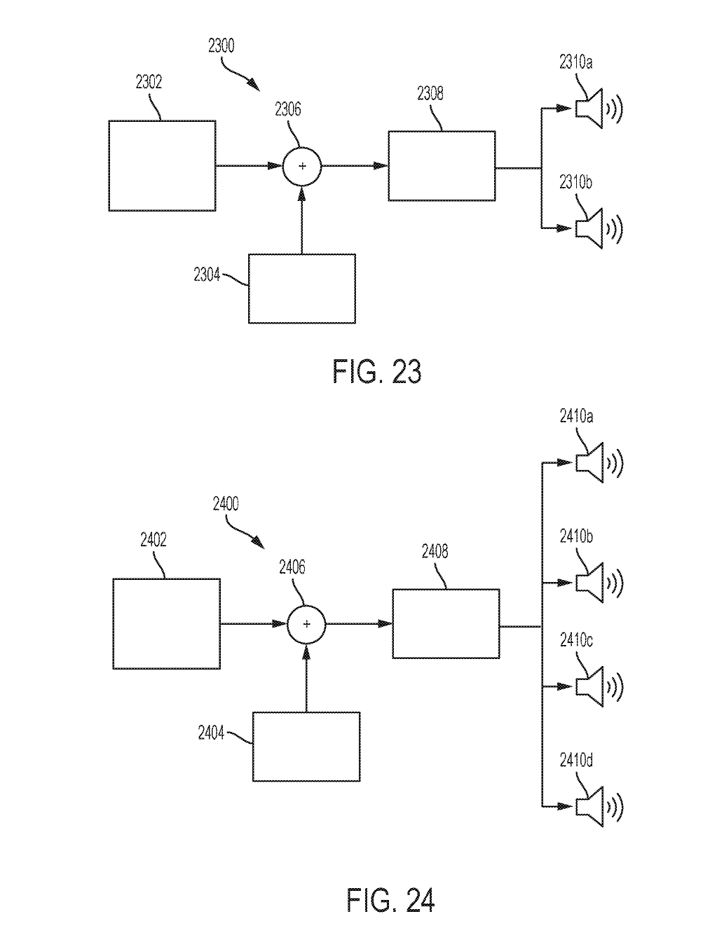

Referring now to FIGS. 23-24, there are shown diagrams of stereo mixing systems according to an aspect of the present disclosure. Ultrasound data communication and localization can be integrated into an audio system, e.g., an audio system of a vehicle, using either software or hardware mixing. Mixing allow ultrasound audio to be added to an existing audio stream from the audio system. This allows the user to listen to their music or audio, while simultaneously allowing ultrasound communication and location to work without impacting the user's experience.

In an illustrative aspect depicted in FIG. 23, the audio system 2300 can include two audio sources or speakers (2310a,b). In an illustrative aspect depicted in FIG. 24, the audio system 2400 can include four audio sources or speakers (2410a-d). Each audio system (2300, 2400) may include an audio source (2302, 2402, respectively) sound sources including, without limitation, CD, FM/AM/XM radio, GPS prompt, audio auxiliary input, Bluetooth handset, any other such audio source.

Each audio system (2300, 2400) may further include an ultrasound audio source (2304, 2404, respectively). The ultrasound audio source (2304, 2404) may create ultrasound pulses which may be used by a mobile device to determine its position in a vehicle. The ultrasound audio source (2304, 2404) may also be used to construct data streams and/or command strings to transmit to the mobile device. For example, the ultrasound source (2304, 2404) may have the capability to automatically adjust volume and the balance between the audio sources, e.g., left/right balance. Ultrasound sources can have the ability to automatically detect the native or default sampling rate of the system and automatically adjust the ultrasound sampling rate to match the system sampling rate.

Each audio system (2300, 2400) further includes a mixer (2306, 2406, respectively) which may perform a linear addition that combines data derived from the audio source (2302,2402) with the data derived from the ultrasound audio source (2304, 2404) on a channel by channel basis. Since the audio source (2302,2402) and the ultrasound audio source (2304, 2404) may have different sampling rates, the mixer (2306, 2406) may have to perform up-sampling or down-sampling before mixing. The mixer (2306, 2406) can be configured to automatically adjust the volume and the balance of ultrasound to ensure sufficient ultrasound volume for location and detection of the mobile device. In one aspect, the mixer (2306, 2406) can be implemented in hardware, e.g., using a processor, an amplifier, and a DSP. In another aspect, the mixer (2306, 2406) can be implemented in software, e.g., using linear addition, software libraries such as ALSA (Advanced Linux Sound Architecture), OSS (Open Sound System), or other custom software audio packages. The output of the mixer (2306, 2406) may form an input to one or more speak amplifiers (2308, 2408) which may provide power for energizing the speakers, 2310a,b (two audio channel system, in audio system 2300) or 2410a-d (four audio channel system, in audio system 2400). It may be recognized that a four audio channel system 2400 may improve the dimensional localization and accuracy of the system.

If the volume of any of one or more of the audio sources is too low, then the audio sources may be unable to be utilized for location detection and communication. In some audio systems, e.g., the audio system of a vehicle, the user often has the control over volume of the audio sources and might choose an overall volume for the audio system or a volume balance between them audio sources that interferes with ultrasound communication and location of the presently disclosed system. Therefore, in some aspects, the system includes software, hardware, or a combination thereof that is configured to automatically detect an imbalance in audio source volume and adjust the volume for each stereo channel. This prevents a user defining a skewed balance between the audio sources that interferes with ultrasound location and communication of the system. For example in aspects including a left speaker and a right speaker, if the system has detected the left and right balance is biased towards the right and left volume is low, the system can then boost the ultrasound volume on the left channel in order to compensate for the imbalance and thus allow the system to function properly.

In some aspects, the system includes software, hardware, or a combination thereof that is configured to automatically detect if the overall volume of the audio source system is too low and then adjust the volume of the audio source system. For example, in aspects where ultrasound communication has been implemented in an audio system, e.g., a speaker system of a vehicle, the user can choose to adjust the volume to a level below the requirement for ultrasound data communication and location. The system can thus compensate by detecting the existing volume setting and then adjusting the volume of the ultrasound output accordingly to ensure that the audio source system is emitting a sufficient volume of ultrasound for robust ultrasound communication and localization. In these aspects, the system can also be configured to compensate and provide automatic volume adjustment when the user set the volume of the audio system too high. When volume is very high, the audio sources may be overdriven, which produces audible acoustic distortion. The system can be configured to compensate by detecting the existing volume and then adjusting the volume of ultrasound to ensure robust ultrasound communication and localization while minimizing audible distortion.

Timing of the transmission of the acoustic signals by the transmitters can be utilized to improve the signal-to-noise ratio, allow multiple access, prevent detection and tampering of the transmission, and provide transceiver synchronization. In one aspect, the transmission and receiving of the acoustic signals can occur at different time slots, so that only one transmitter is broadcasting an acoustic signal at same time in order to reduce interference. A guard time can be inserted between the transmission and the receiving time slot to ensure that the two time slots do not overlap. In one aspect, the transmitters can each be assigned a non-overlapping time slot in which to transmit, which is referred to as time division multiple process. In one aspect, transmission time slots can be assigned in such way that it is difficult for a third party to monitor and listen in. This prevents detection and tampering by other device of the acoustic signals. In one aspect, the transmission time slots can also arranged in time with a certain order or pattern, such that multiple receivers can monitor the transmissions and infer the time and adjust timing or synchronize.

In one aspect, the data communication and localization modules are implemented in software on a mobile device, e.g., a mobile phone, a tablet, or a wearable. The mobile device may be configured to adjust the processing speed of its processor in order to maximize battery life. This variability in processor speed of mobile devices can lead to indeterministic speed in executing acoustic data and communication operations. Therefore in one aspect, the data communication and localization software are configured to monitor and adjust for different processor speeds to ensure correct operation. One such implementation includes the iterative steps of performing data communication and localization calculations, record the timing of execution, and then adjusting the expected execution time for the next iteration, wherein if time of execution is longer than expected, the processing time for the next iteration is increased, and If time of execution is shorter than expected, the processing time for the next iteration is decreased.

In one aspect, the system can be configured to automatically adjust the quality of the sound channel to achieve a desired balance between data rate and robustness. Specifically, the system can adjust the carrier frequency, data rate, and transmission power of the sound transmission channel. The table below summarizes examples for ways in which the carrier frequency, data rate, and transmission power parameters of the sound channel can be adjusted:

TABLE 2
Ultrasound Carrier Properties and Audio Channel Quality

| | Presence of high quality | Presence of poor channel |
|---|---|---|
| | channel (low noise, low | quality (high noise, high |
| Parameter | interference) | interference) |
| Carrier | Use higher carrier frequency | Use lower carrier frequency |
| Frequency | to achieve higher data bit | to improve noise immunity. |
| | rate. | OR |
| | | Scan the frequency and |
| | | choose a carrier frequency |
| | | where interference is the |
| | | lowest. |
| Data Rate | Use higher data rate because | User lower data rate or higher |
| | data transmission bit error | powered error correction |
| | rate is lower in a high quality | code to compensate for |
| | channel. | higher bit error rate in low |
| | | quality channel. |
| Transmis- | Reduce transmission power. | Increase transmission power |
| sion | | to increase signal to noise |
| Power | | ratio. |

In order to enhance the security of the transmission of the acoustic signals, the acoustic signals can be encrypted using a security key in one aspect. Encryption of the acoustic signals provides security and only the receiver, i.e., mobile device, can decode the message with a corresponding decryption key.

In one aspect, the acoustic signals can also be transmitted with redundant data bits to provide error detection and/or error correction. Examples of error detection schemes include, without limitation, repetition codes, parity bits, checksum, cyclic redundancy checks, cryptographic hash, and error detection code. Examples of error correction schemes include, without limitation, automatic repeat requests, error correction code, and a hybrid of retransmission and error correction code. For error correction code, examples include, without limitation, Hamming Code, Reed-Solomon code, and BCH code.

A phenomenon called the near-far problem occurs in ultrasonic data transmission. Mathematically, the near-far problem arises because signal strength becomes weaker when a transmitter is far away from a receiver, as signal=K/d² where K is a constant and d is the distance between the transmitter and receiver. The near-far problem can be adjusted by adjusting the transmission power of the acoustic signals. In one aspect, when the receiver receives a transmission from a transmitter at a far distance, the receiver can reply to the original transmitter to request a higher transmission power for the transmitted acoustic signal. When the transmitter retransmits the acoustic signal at a higher power, the received signal strength at the receiver is higher in order to overcome the distance.

In one aspect, each transmitter can have unique identification number or text that is transmitted with the acoustic signals in order to assist in data communication, localization, and mapping. In some aspects, the unique ID can be configured to function in a similar to media access control address (MAC address) of a networking device or a universally unique identifier (UUID) of a Bluetooth device.

In one aspect wherein the system is adapted for use with a native audio system, the present system can be configured to match the sampling rate of the ultrasonic audio signals to that the native sampling rate of the operating system. For Android, Linux, and iOS operating systems, the typical sampling rate is 44.1 KHz or 48 KHz. By matching the ultrasound sampling rate to that of native sampling rate, the OS does not need to perform up-sampling or down-sampling, which prevents additional computation overhead, distortion, and non-linearity.

For example, to integrate ultrasound location and communication to a vehicle, one should first identify the native sampling rate of the audio system of the vehicle. Then create the ultrasound output that matches the native sampling rate of the audio system. If it is not feasible to match the native sampling rate, then signal processing techniques such as filtering are probably required to reduce the non-linearity and distortion caused by up-sampling or down-sampling.

The present data communication and location system can be further facilitated by additional sensor information. In one aspect, the system can include a light source or a magnet that functions as a beacon to provide a second, supplementary method for proximity detection. In another aspect, the system can include an accelerometer sensor configured to detect movement and combine the motion information with ultrasound location in order to supplement the function of the present system and improve accuracy. In yet another aspect, the system can include a magnetometer sensor configured to provide heading or direction information to facilitate ultrasound location.

The present ultrasonic location system can be configured to divide a space, e.g., the interior of a vehicle, into multiple zones based on configurable parameters. For example, in one aspect the system configured for use in a vehicle, the vehicle interior can be divided into a driver zone and a passenger zone. The parameters establishing the driver zone can then be preset or programmed by the user.

The present system can comprise multiple timers to control the function of a mobile device or various other components or features of the system. In one aspect, the system comprises a timer configured to keep the screen of the mobile device locked even after the device has moved to the passenger zone from the driver zone. The timer preventing the screen of a mobile device from immediately unlocking after leaving the driver zone prevents the user from attempting to circumvent the screen lock initiated when the mobile device is in the driver zone by quickly extending the mobile device over to the passenger zone. The delay tracked or associated with the timer can be preset or programmed by the user.

The ultrasound location and communication system as implemented in software, hardware, or a combination thereof on a mobile device can be configured to run in the background in order to provide continuous or on-demand location and data communication. In various aspects, the system can be configured to automatically start up bootup of the mobile device, can be configured to detect when it is being closed and automatically restart or schedule a restart in order to prevent tampering by closing the software, and run in the background of the mobile device and minimize the user interface.

One advantage of applying a spread spectrum communication over ultrasound is that by using a wider frequency band, the power at any specific frequency is greatly lowered. This generates several benefits: robustness against narrowband interference, increased tempering-resistance as wide band signals are harder to detect, coexistence of multiple transmitters and receivers, no need to pre-allocated frequencies for each device (as all devices will use the same bandwidth), and less prone to fading.

Furthermore, by utilizing time information from the transmission of the acoustic signals, localizing the transmitters can be calculated at the same time as data is communicated to the receiver. In other words, the localization and data communication modules can function simultaneously.

In one aspect, the present system is configured to differentiate a driver from passengers in a vehicle. This identification allows targeted communication based on the location of each person so that drivers are not distracted from the primary task and passengers are able to take advantage of all vehicle features such as navigation, entertainment, and climate control. In one aspect, the management platform of the system provides a mechanism for the application developer or the account manager to identify and control the interaction parameters. The system can also integrate GPS information from them mobile device or the vehicle to allow customization of features based on movement.

The present system allows the acoustic signals to be used as a configuration and profile exchange channel in a variety of environments. For example, in a vehicle the acoustic signals can communicate basic vehicle configurations to the mobile device and the mobile device can in turn send profile information to the vehicle using the embedded microphone. In one aspect, this information exchange can then trigger the device application to initiate a higher bandwidth data exchange protocol such as Bluetooth, or LTE. This enables extensive interaction with the passengers and allows a variety of streaming services that can be initiated from the mobile device.

In one aspect, the system includes a single transmitter and does not include localization functionality for the mobile device. In this aspect, the acoustic signals can simply trigger an action on the mobile device including, without limitation, exchanging profile information, transmitting a safety alert to the mobile device, disabling the screen of the mobile device, or performing application-specific activities.

In one aspect, the system is configured to grant access to a mobile device in communication with the system. In this aspect, when the mobile device comes within range of the transmitter assembly or a secure access point configured to transmit the acoustic signals, the system can be configured to automatically exchange secure data messages between the access point and the mobile device. The access point device then can grant or deny access to the mobile device based on the content of the data messages. In another aspect, the system can be configured to recognize the user based upon the particular mobile device and then automatically download the user's profile from, e.g., the cloud. In another aspect, the system can be configured to recognize the user as a passenger within the vehicle and then customize the user interactions from the system to be different than the user interactions provided to, e.g., a driver.

In one aspect, ultrasonic data communication can be utilized to replace the functionality of a vehicle key fob in order to unlock an automobile. In this aspect, the automobile and the mobile device each transmit their location as determined via GPS, WiFi, BLE, or another such technique to a verification system. The verification system can include, without limitation, a database, a computer cloud computing system, or a server. If it is determined that both the automobile and the mobile device are in the approximately the same geographical location, then the automobile and the smart device begin communicating via the acoustic signals. For example, the speakers of the automobile begin transmitting the acoustic signals and the microphone of the mobile device begins receiving the acoustic signals. If the automobile and the mobile device are in close enough proximity, then they will be able to establish ultrasonic data communication between each other. The automobile and the mobile device can thereafter exchange data, including encrypted messages. The smart device can in turn transmit messages to the automobile via the microphone, which are received by receivers in the automobile. The messages transmitted by the mobile device can include, without limitation, unlocking the vehicle automatically or on-demand by the user through the software application stored in a memory on the mobile device.

In other aspects, additional vehicle key fob functionality can be provided by the present system. In one aspect, a mobile device can be utilized to lock the automobile through a software application stored on the mobile device. In this aspect, the mobile device can transmit an ultrasonic message or signal, which is received by receivers of the vehicle. In response to receiving the unlock signal from the mobile device, the vehicle can then unlock.

In one aspect, the system can be configured to automatically lock the car. In this aspect, when the mobile device and the automobile are no longer in ultrasonic communication with each other, the system will initiate a second localization technique. The mobile device and the automobile no longer being in ultrasonic communication with each other indicates that they are relatively far away from each other. The second localization technique is utilized to confirm that the mobile device and the automobile are relatively far from each other. The second localization technique can include, without limitation, GPS, WIFI or BLE location services. The system can then automatically lock the vehicle based on user's preset preferences including, without limitation, the distance between the mobile device and the automobile and the time that the mobile device and the automobile are out of range from each other.

In one aspect, the localization and data communication modules can be configured to ensure that the driver is not distracted by his or her phone, so the driver can stay focus on monitoring the vehicle. In this aspect, the system can determine if the driver is potentially distracted by monitoring a variety of variables including, without limitation, if the mobile phone is texting and if applications on the mobile phone are being utilized. In such cases, the localization and data communication module may transmit data over the audio channel that, when received by the mobile device, will cause the mobile device to modify or cease one or more functions of the mobile device including, but not limited to, a texting function, a voice communication function, a photography function, and a web browsing function. If the driver becomes distracted, this system can also measured and report incidents of distraction, warn the driver of the distraction, and turn off source of distractions if possible. The system could also be configured to push alerts or notifications to the driver's cell phone in order to warn a driver whose attention is diverted or notify the driver that there is a situation that requires immediate attention.

Ultrasonic data communication as implemented by the present system can additionally be used to facilitate establishing another network connection, such Bluetooth, Bluetooth Smart/Low Energy, WIFI, LIFI (light-based wifi), LORA, or any other wireless protocol. In case of Bluetooth, a numerical key can be transmitted over ultrasound, i.e., via transmission of audio signals as implemented by the present system, between Bluetooth devices. This allows a secure Bluetooth connection to be established using the numeric comparison or key entry methods of Bluetooth pairing. In case of WIFI, the SSID and/or passcode of the WIFI network can be transmitted to the device via the audio signals generated by the communications module.

In various aspects, ultrasonic communication can additionally be utilized to track items. In one aspect, a warehouse can be installed with ultrasound transmitters or receivers throughout the facility at known locations. An item being tracked is equipped with either an ultrasound transmitter or receiver. As the item moves within the facility, the tracking device is communication with the facility's transmitter or receivers. Depending on the signal strength or triangulation localization result, the precise location of the item being tracked can be determined.

In various aspects, location information provided by the present system can be utilized, e.g., by software, to deliver location specific information. In one aspect, tracking fobs, tracking devices, or mobile devices can be configured to track the location of employees within a facility. As employees move throughout the facility, the mobile device, which can include an ultrasound transmitter, can communicate with transmitters or receivers positioned throughout the facility and thereby determine the location of the employee. Software stored on the mobile device, which is in use by the employee to, e.g., track inventory management, can then be automatically updated in accordance with the location for the employee. For example, if an auditor is in an aisle of a department store, the audit checklist software on the auditor's mobile device can be updated so that only the items in the current aisle are being displayed.

In various aspects, the present system can also be utilized to automatically check-in app users when they arrive at a specific location such as hospitals, schools, worksites, or specific events. In one aspect, the system includes automatic check-in software, e.g., stored on and executable by a mobile device, that can check-in the user when the user reaches a particular location and also capture data about the individual. Automated check-ins could also be used to replace clunky and expensive time tracking software. Lastly, the data generated from automated check-ins could be useful in emergency situations to see who is at a particular location at any given point in time.

In some aspects, the present system can be utilized to deliver content and media based on a user's exact location. In one aspect, a location can be equipped with transceivers that track the location of a mobile device and then deliver specific content based upon the location of that mobile device. For example, information regarding a painting at a gallery could be delivered to a mobile device when the mobile device is in close proximity thereto. As another example, a video review of a car could be delivered to a mobile device when the mobile device is in close proximity thereto. As yet another example, a recipe suggestion could be delivered in the supermarket a recipe suggestion linked to the isle you're standing in. As yet another example, products can have attached beacons or transceivers configured to communicate via ultrasonic signals, which are configured to deliver content to the user's mobile device when the mobile device is in close proximity to the product having the attached beacon or transceiver. Such content can include, without limitation, videos outlining key product specs and features, reviews of the product, and articles or videos demonstrating how to use the product.

In the context of a vehicle application, aspects of the system configured to deliver content and media based on a user's exact location allow differentiated content delivery based on the location of driver and passengers in the vehicle. For example, if the system has detected that a mobile phone is in the driver zone, then the system can be configured to transmit a message to the driver's mobile phone limiting content delivery and user interaction to prevent distracted driving. If the system has detected that a cell phone is not in the driver zone, then the vehicle can push rich content and multimedia experience to the cell phone without restriction. The passenger can also have rich interaction with the infotainment system in the vehicle. For example, the present system can be configured to allow the passenger to view interactive and/or multimedia contents, push navigation information to the head unit of the vehicle, allow the passenger to view a video library (digital TV), autoset claim control preferences, enforce parental controls, or provide for the targeted delivery of other content.

In one aspect, the mobile device and the vehicle are configured to exchange calibration data in order to effectuate prior to establishing a communications link or during the course of the communications link therebetween.

In some aspects, the system is additionally configured to track media attribution in users. The purpose of media attribution is to quantify the influence each advertising impression has on a consumer's decision to make a purchase decision, or convert, allowing marketers to better optimize media spend for conversions. While this is easily achieved online due to advanced tracking solutions, understanding real-world interactions is a little more challenging. Beacons provide a whole new data set that can be fed into media attribution models to better understand how online advertising drives offline behavior and vice versa. In one aspect, the system can be configured to track users' proximity to items that the users had previously viewed and advertisement of. For example, if a user sees an online ad for an automobile and decides to click on it, that impression from the ad can be tacked by an online advertising system. If the user then later decides to stop into a dealership and check out the same automobile, that conversion can then be tracked. Specifically, an aspect of the system can include a beacon or transmitter associated with an item, e.g., an automobile. When the user's mobile device detects the presence of a beacon in the dealership, the system records the visit or records actions taken with the item, e.g., a test drive of the automobile, against the user's unique customer ID. The system can therefore track and link online impressions to physical, offline conversions over periods of time.

In one aspect, the system can be configured to create engaging and interactive experiences for attendees of an event. For example, the system can be configured to automatically deliver or track electronic tickets as attendees walk into a location or event and then push seating information, directions, or information on the event, e.g., a keynote speaker's bio, to the mobile device. In one aspect, the system can be configured to detect feedback from users in a specific location utilizing the data communication teachings discussed above. In one aspect, the system can be configured to create a detailed map for navigation and user interaction utilizing the localization and proximity data teachings discussed above.

In another aspect the system can be configured specifically for use in ride-sharing vehicles, equipment, and devices. In one such aspect of the system as implemented in connection with a ride-sharing vehicle or a taxi, the communications module of the system can be configured to automatically identify the passenger based upon the passenger's mobile device when the passenger nears or enters the vehicle. Once the passenger has been identified, the system can be configured to automatically grant access to the vehicle, download the user's profile, link billing, push preferences and multimedia content, and allow the rideshare fare to be split among multiple passengers identified by the present system.

In another aspect, the system can be adapted for use by insurance companies. In this application, the system can be configured to identify the driver via the communications module as discussed herein. Insurance companies can then provide individualized insurance policies that are tailored for each specific driver. In addition, vehicle telemetry data can be combined with the identity of the driver of the vehicle in order to allow the insurance companies to monitor the driving habits of the policyholders in order to more accurately assess the risks of each driver. If the automobile or the system detects the occurrence of an accident, then the driver and all passengers can be identified using the ultrasound location and data communication protocols of the present system. Based on the identity of the riders, a third party can dispatch emergency personnel, e.g., an ambulance, and transmit information about the riders, such as their identities, to the emergency personnel.

In utilizing ultrasound-based location detection, the coordinate and angle/direction of an ultrasound sonar-capable device can be determined. Angle of arrival is useful for searching an ultrasound sonar-capable device.

The present ultrasound location and data communication interface of the present system can be opened up to third party software through software application programming interface (API) or software development kit (SDK). This allows third party apps to access location information and send and receive data over ultrasound via interaction or communication with the present system.

The ultrasound detection algorithm or any other algorithm or logic of the present system can be implemented in software, hardware, or any combination thereof. In aspects implemented in hardware, the algorithms or modules of the present system can take the form of an application specific integrated circuit (ASIC) chip, a system on a chip (SOC) or a portion thereof, a microcontroller (MCU) or a portion thereof, or digital signal processor (DSP) or a portion thereof. In aspects where the system or portions of the system are implemented in hardware, the hardware components can include, without limitation, a digital signal processing or central processing unit to implement or execute the ultrasound location and communication algorithm, a memory or non-transitive storage medium configured to store the logic or algorithm for processing, a microphone pre-amplifier, a microphone gain control, a microphone, a speaker amplifier, a speaker, a buzzer, a transducer, and a digital interface, e.g., a UART, I2C, SPI, or a serial interface or parallel interfaces configured to communicate with external semiconductor ICs. Hardware-based implementations can provide: an expanded frequency range, e.g., 15 KHz to 80 KHz, due to utilizing a custom microphone and speaker; a reduced power requirement due to custom electronics configured to support the ultrasonic communication and localization of the system; a reduced system power requirement due to the CPU of the mobile device offloading the ultrasonic communication and localization processing to the custom electronics; the ability to place ultrasound transducers at locations other than the typical speaker or microphone positions associated with, e.g., automobiles; and allow for placement of multiple transducers.

While various details have been set forth in the foregoing description, it will be appreciated that the various aspects of the methods, devices, and systems as disclosed may be practiced without these specific details. One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Further, while several forms have been illustrated and described, it is not the intention of the applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

For conciseness and clarity of disclosure, selected aspects of the foregoing disclosure have been shown in block diagram form rather than in detail. Some portions of the detailed descriptions provided herein may be presented in terms of instructions that operate on data that is stored in one or more computer memories or one or more data storage devices (e.g. floppy disk, hard disk drive, Compact Disc (CD), Digital Video Disk (DVD), or digital tape). Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

Unless specifically stated otherwise as apparent from the foregoing disclosure, it is appreciated that, throughout the foregoing disclosure, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. In one form, several portions of the subject matter described herein may be implemented via an application specific integrated circuits (ASIC), a field programmable gate array (FPGA), a digital signal processor (DSP), or other integrated formats. However, those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In some instances, one or more elements may be described using the expression “coupled” and “connected” along with their derivatives. It should be understood that these terms are not intended as synonyms for each other. For example, some aspects may be described using the term “connected” to indicate that two or more elements are in direct physical or electrical contact with each other. In another example, some aspects may be described using the term “coupled” to indicate that two or more elements are in direct physical or electrical contact. The term “coupled,” however, also may mean that two or more elements are not in direct contact with each other, but yet still co-operate or interact with each other. It is to be understood that depicted architectures of different components contained within, or connected with, different other components are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated also can be viewed as being “operably connected,” or “operably coupled,” to each other to achieve the desired functionality, and any two components capable of being so associated also can be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components, and/or electrically interacting components, and/or electrically interactable components, and/or optically interacting components, and/or optically interactable components.

In other instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present disclosure have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “one form,” or “a form” means that a particular feature, structure, or characteristic described in connection with the aspect is included in at least one aspect. Thus, appearances of the phrases “in one aspect,” “in an aspect,” “in one form,” or “in an form” in various places throughout the specification are not necessarily all referring to the same aspect. Furthermore, the particular features, structures or characteristics may be combined in any suitable manner in one or more aspects.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

All of the above-mentioned U.S. patents, U.S. patent application publications, U.S. patent applications, foreign patents, foreign patent applications, non-patent publications referred to in this specification and/or listed in any Application Data Sheet, or any other disclosure material are incorporated herein by reference, to the extent not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

Various aspects of the subject matter described herein are set out in the following numbered examples:

### Example 1

A system comprising:

a plurality of transmitters, wherein each transmitter of the plurality of transmitters is configured to transmit an ultrasonic acoustic signal and wherein at least one ultrasonic acoustic signal is a modulated ultrasonic acoustic signal; and

a mobile device comprising a processor, a receiver, and instructions stored on a non-transitory memory, wherein when the instructions are executed by the processor, the instructions cause the mobile device to:
receive the ultrasonic acoustic signal transmitted by each of the plurality of transmitters;
calculate a position of the mobile device based upon one or more characteristics of the ultrasonic acoustic signal transmitted by each of the plurality of transmitters; and
demodulate the modulated ultrasonic acoustic signal to obtain an information data stream.

### Example 2

The system of example 1, wherein the one or more characteristics of the ultrasonic acoustic signal transmitted by each of the plurality of transmitters comprises a time of flight of the ultrasonic acoustic signal transmitted by each of the plurality of transmitters.

### Example 3

The system of example 1, wherein the one or more characteristics of the ultrasonic acoustic signal transmitted by each of the plurality of transmitters comprises a carrier frequency and an amplitude of the ultrasonic acoustic signal transmitted by each of the plurality of transmitters.

### Example 4

The system of example 1, wherein each ultrasonic acoustic signal is an ultrasonic acoustic signal having a central carrier frequency within a range of 15 KHz to 25 KHz.

### Example 5

The system of example 1, wherein each transmitter of the plurality of transmitters is a speaker disposed within a vehicle.

### Example 6

The system of example 5, wherein when the instructions stored on the memory are executed by the processor, the instructions further cause the mobile device to determine that the calculated position of the mobile device is within a predetermined detection zone within the vehicle.

### Example 7

The system of example 6, wherein when the instructions stored on the memory are executed by the processor, the instructions further cause the mobile device to inhibit at least one function of the mobile device when the calculated position of the mobile device is within the predetermined detection zone within the vehicle.

### Example 8

The system of example 5, further comprising an audio system in data communication with the plurality of transmitters.

### Example 9

The system of example 8, further comprising an audio mixer, wherein the audio mixer is configured to combine an audio output of the audio system with the ultrasonic acoustic signal transmitted by at least one of the plurality of transmitters.

### Example 10

The system of example 8, wherein the audio system further comprises an audio system circuit configured to receive an encoded wireless transmission signal from the mobile device, and wherein the encoded wireless transmission signal comprises the ultrasonic acoustic signal transmitted by at least one of the plurality of transmitters.

### Example 11

The system of example 1, wherein the information data stream comprises one or more of an identity of the transmitter transmitting the modulated ultrasonic acoustic signal, a transmitter calibration information, a carrier frequency of the modulated ultrasonic acoustic signal, a bandwidth of the modulated ultrasonic acoustic signal, phase of the modulated ultrasonic acoustic signal, a symbol encoding of the modulated ultrasonic acoustic signal, and a power level of the modulated ultrasonic acoustic signal.

### Example 12

The system of example 1, wherein the modulated ultrasonic acoustic signal comprises an ultrasonic acoustic signal having a ultrasound carrier wave modulated in one or more of an amplitude, a phase, and a frequency.

### Example 13

The system of example 1, wherein the plurality of transmitters comprises three transmitters.

### Example 14

A method comprising:

receiving, by a receiver of a mobile device, a plurality of ultrasonic acoustic signals wherein each of the plurality of ultrasonic acoustic signals is transmitted by a transmitter and wherein at least one of the ultrasonic acoustic signals is a modulated ultrasonic acoustic signal;

calculating, by the mobile device, a position of the mobile device based upon one or more characteristics of the plurality of ultrasonic acoustic signals; and

demodulating the modulated ultrasonic acoustic signal to obtain an information data stream.

### Example 15

The method of example 14, wherein demodulating the modulated ultrasonic acoustic signal comprises one or more of frequency demodulating, amplitude demodulating, and phase demodulating.

### Example 16

The method of example 14, wherein calculating, by the mobile device, a position of the mobile device based upon one or more characteristics of the plurality of ultrasonic acoustic signals comprises calculating a position of the mobile device based upon a time of flight of each of the plurality of ultrasonic acoustic signals.

### Example 17

The method of example 14, wherein calculating, by the mobile device, a position of the mobile device based upon one or more characteristics of the plurality of ultrasonic acoustic signals comprises calculating a position of the mobile device based upon a carrier frequency and an amplitude of each of the plurality of ultrasonic acoustic signals.

### Example 18

The method of example 14, further comprising:

determining that the calculated position of the mobile device is within a predetermined detection zone within a vehicle; and

inhibiting at least one function of the mobile device when the calculated position of the mobile device is within the predetermined detection zone within the vehicle.

### Example 19

The method of example 14, further comprising:

encoding, by the mobile device, at least one of the ultrasonic acoustic signals in an encoded wireless transmission signal; and

transmitting the encoded wireless transmission signal to a receiving circuit in data communication with at least one transmitter of the ultrasonic acoustic signals.

We claim:

1. A system comprising:
a plurality of transmitters, wherein each transmitter of the plurality of transmitters is configured to transmit an ultrasonic acoustic signal and wherein at least one ultrasonic acoustic signal is a modulated ultrasonic acoustic signal; and
a mobile device comprising a processor, a receiver, and instructions stored on a non-transitory memory, wherein when the instructions are executed by the processor, the instructions cause the mobile device to:
receive the ultrasonic acoustic signal transmitted by each of the plurality of transmitters;
calculate a position of the mobile device based upon one or more characteristics of the ultrasonic acoustic signal transmitted by each of the plurality of transmitters; and
demodulate the modulated ultrasonic acoustic signal to obtain an information data stream.

2. The system of claim 1, wherein the one or more characteristics of the ultrasonic acoustic signal transmitted by each of the plurality of transmitters comprises a time of flight of the ultrasonic acoustic signal transmitted by each of the plurality of transmitters.

3. The system of claim 1, wherein the one or more characteristics of the ultrasonic acoustic signal transmitted by each of the plurality of transmitters comprises a carrier frequency and an amplitude of the ultrasonic acoustic signal transmitted by each of the plurality of transmitters.

4. The system of claim 1, wherein each ultrasonic acoustic signal is an ultrasonic acoustic signal having a central carrier frequency within a range of 15 KHz to 25 KHz.

5. The system of claim 1, wherein each transmitter of the plurality of transmitters is a speaker disposed within a vehicle.

6. The system of claim 5, wherein when the instructions stored on the memory are executed by the processor, the instructions further cause the mobile device to determine that the calculated position of the mobile device is within a predetermined detection zone within the vehicle.

7. The system of claim 6, wherein when the instructions stored on the memory are executed by the processor, the instructions further cause the mobile device to inhibit at least one function of the mobile device when the calculated position of the mobile device is within the predetermined detection zone within the vehicle.

8. The system of claim 5, further comprising an audio system in data communication with the plurality of transmitters.

9. The system of claim 8, further comprising an audio mixer, wherein the audio mixer is configured to combine an audio output of the audio system with the ultrasonic acoustic signal transmitted by at least one of the plurality of transmitters.

10. The system of claim 8, wherein the audio system further comprises an audio system circuit configured to receive an encoded wireless transmission signal from the mobile device, and wherein the encoded wireless transmission signal comprises the ultrasonic acoustic signal transmitted by at least one of the plurality of transmitters.

11. The system of claim 1, wherein the information data stream comprises one or more of an identity of the transmitter transmitting the modulated ultrasonic acoustic signal, a transmitter calibration information, a carrier frequency of the modulated ultrasonic acoustic signal, a bandwidth of the modulated ultrasonic acoustic signal, phase of the modulated ultrasonic acoustic signal, a symbol encoding of the modulated ultrasonic acoustic signal, and a power level of the modulated ultrasonic acoustic signal.

12. The system of claim 1, wherein the modulated ultrasonic acoustic signal comprises an ultrasonic acoustic signal having a ultrasound carrier wave modulated in one or more of an amplitude, a phase, and a frequency.

13. The system of claim 1, wherein the plurality of transmitters comprises three transmitters.

14. A method comprising:
receiving, by a receiver of a mobile device, a plurality of ultrasonic acoustic signals wherein each of the plurality of ultrasonic acoustic signals is transmitted by a transmitter and wherein at least one of the ultrasonic acoustic signals is a modulated ultrasonic acoustic signal;
calculating, by the mobile device, a position of the mobile device based upon one or more characteristics of the plurality of ultrasonic acoustic signals; and
demodulating the modulated ultrasonic acoustic signal to obtain an information data stream.

15. The method of claim 14, wherein demodulating the modulated ultrasonic acoustic signal comprises one or more of frequency demodulating, amplitude demodulating, and phase demodulating.

16. The method of claim 14, wherein calculating, by the mobile device, a position of the mobile device based upon one or more characteristics of the plurality of ultrasonic acoustic signals comprises calculating a position of the mobile device based upon a time of flight of each of the plurality of ultrasonic acoustic signals.

17. The method of claim 14, wherein calculating, by the mobile device, a position of the mobile device based upon one or more characteristics of the plurality of ultrasonic acoustic signals comprises calculating a position of the mobile device based upon a carrier frequency and an amplitude of each of the plurality of ultrasonic acoustic signals.

18. The method of claim 14, further comprising:
determining that the calculated position of the mobile device is within a predetermined detection zone within a vehicle; and
inhibiting at least one function of the mobile device when the calculated position of the mobile device is within the predetermined detection zone within the vehicle.

19. The method of claim 14, further comprising:
encoding, by the mobile device, at least one of the ultrasonic acoustic signals in an encoded wireless transmission signal; and
transmitting the encoded wireless transmission signal to a receiving circuit in data communication with at least one transmitter of the ultrasonic acoustic signals.
